(19) United States
(12) Patent Application Publication
(10) Pub. No.: US 2026/0361451 A1
(43) Pub. Date: Nov. 12, 2026

(54) DYNAMIC IMPEDANCE ADAPTIVE SYMBOL ENCODING AND DECODING

(71) Applicant: Intel Products IP LLC, Santa Clara, CA (US)

(72) Inventor: Aruni NELSON, Rocklin, CA (US)

(21) Appl. No.: 19/719,278

(22) Filed: Jun. 25, 2026

(51) Int. Cl. H04L 1/00; H04L 25/02

(52) U.S. Cl. CPC H04L 1/0034; H04L 25/0278

(57) ABSTRACT

An apparatus including: a processor configured to: determine an impedance profile of a communication channel based on a measurement of the communication channel; select, based on the impedance profile, a set of symbol encoding parameters from a plurality of sets of symbol encoding parameters, each set of symbol encoding parameters being representative of a respective time-domain symbol shape; and encode, based on the selected set of symbol encoding parameters, digital data for transmission over the communication channel.

### BACKGROUND

Conventional encoding schemes for digital communication over physical channels employ fixed or predefined configurations to represent digital symbols as electrical waveforms. The electrical characteristics of a physical communication channel, which may include impedance, insertion loss, and reflection behavior, influence the integrity of signals propagated over the channel. A mismatch between the fixed encoding parameters used by a transmitter and the actual electrical state of the channel may result in signal distortion, waveform degradation, and increased error rates at the receiver. Channel electrical characteristics are subject to variation during operation, arising from factors including mechanical wear, temperature changes, and electromagnetic interference. These apply to encoding and decoding schemes used in both wired interconnect and wireless communication contexts.

In wired interconnect applications, physical conductors including differential pairs, cable assemblies, and connector interfaces carry electrical signals between devices, and the electrical characteristics of such conductors are subject to variation arising from mechanical stress, thermal expansion, oxidation, and connector wear. In wireless communication applications, the effective channel response between a transmitter and a receiver varies as a function of propagation conditions, including multipath reflections and transceiver front-end characteristics such as antenna impedance. Across both contexts, encoding schemes translate digital data into transmitted waveforms according to defined symbol parameters, and the degree to which those parameters reflect the actual channel state at the time of transmission affects signal integrity and error performance.

### BRIEF DESCRIPTION OF THE DRAWINGS

In the drawings, like reference characters generally refer to the same parts throughout the different views. The drawings are not necessarily to scale, emphasis instead generally being placed upon illustrating the principles described herein. In the following description, various aspects are described with reference to the following drawings, in which:

FIGS. 1 and 2 depict a general network and device architecture for wireless communications and/or sensing operations;

FIG. 3 illustrates an example of an apparatus in accordance with various aspects described herein;

FIG. 4 illustrates an example of a high-level block diagram of encoder and decoder portions of the apparatus 300;

FIG. 5 illustrates an example of symbol encoding using variable symbol timing duration;

FIG. 6 illustrates an example of symbol encoding using the S3 asymmetric-edge NRZ shape;

FIG. 7 shows an example of a method;

FIG. 8 shows an example of a method.

### DESCRIPTION

The following detailed description refers to the accompanying drawings that show, by way of illustration, exemplary details and aspects in which aspects described herein may be practiced.

Various aspects described herein relates to encoding and decoding of digital data for transmission over communication channels. Communication channels over which the aspects described herein apply include wired channels, comprising physical conductors such as differential pairs, cable assemblies, and printed circuit board traces over which electrical signals propagate, and wireless channels, comprising radio frequency propagation paths over which electromagnetic signals are transmitted and received. Encoding a digital data stream into electrical or electromagnetic waveforms and subsequently recovering the digital data from received waveforms are operations in communication systems operating over such channels.

Known encoding schemes for wired interconnects, including non-return-to-zero (NRZ), pulse-amplitude modulation with three or four levels (PAM-3/4), and quadrature amplitude modulation (QAM), employ fixed amplitude and phase levels and fixed edge shapes. Existing standards including universal serial bus (USB), peripheral component interconnect express (PCIe), Thunderbolt, DisplayPort, high-definition multimedia interface (HDMI), mobile industry processor interface (MIPI), serial advanced technology attachment (SATA), and Ethernet may use fixed or semi-adaptive equalization at the receiver, through techniques such as continuous-time linear equalization (CTLE), decision feedback equalization (DFE), and feed-forward equalization (FFE), to compensate for channel damage. These approaches rely on the receiver's equalization to compensate for channel impairments rather than proactively shaping the transmitted symbol to the channel's current electrical state.

Known encoding schemes for wireless communication employ modulation formats in which digital data is mapped to predefined symbol constellations defined by fixed amplitude and phase levels, including binary phase-shift keying (BPSK), quadrature phase-shift keying (QPSK), and quadrature amplitude modulation variants such as 16-QAM, 64-QAM, and 256-QAM, commonly carried on orthogonal frequency-division multiplexing (OFDM) waveforms. Existing wireless standards including 5G NR, LTE, WiFi (IEEE 802.11), Bluetooth, and ultra-wideband (UWB) employ receiver-side channel estimation using pilot or reference signals, combined with link adaptation mechanisms that select a modulation and coding scheme based on estimated channel quality. These approaches adapt the modulation order and code rate to measured channel conditions, but the geometric shape of the transmitted symbol, such as the voltage or phase trajectory over the symbol period, remains fixed for a given modulation order and is not adjusted based on the instantaneous impedance or channel response characteristics of the transmitter hardware.

Existing systems are not designed for rapid, continuous adaptation to dynamic channel changes, such as connector movement, flexing cables, or thermal drift in wired interconnects. Standard symbol geometries are globally defined, and once a physical line is accessed, received data may be recovered using standard tools, as no coupling exists between the physical channel characteristics and the symbol definition. The fixed nature of existing encoding configurations prevents compensation for actual channel behavior, resulting in inefficient use of channel margin. Pre-emphasis, de-emphasis, and equalization in existing systems are applied as global filters rather than as per-symbol geometry adjustments, which limits the precision with which such techniques can counteract complex impedance profiles or localized reflections. Further, channel estimation in systems configured with wireless interconnects is performed periodically rather than continuously, and the symbol shapes employed are standardized and globally defined, providing no inherent coupling between the physical channel impedance characteristics and the symbol waveform geometry.

A communication channel, for the purposes of the aspects described herein, may comprise a wired channel or a wireless channel. A wired communication channel may include a physical medium such as a coaxial cable, twisted-pair conductor pair, stripline or microstrip trace on a printed circuit board, or connector assembly, over which electrical signals propagate between a transmitter and a receiver. Signal propagation over wired channels may be governed by the distributed electrical properties of the medium, including characteristic impedance, series resistance and inductance per unit length, and shunt capacitance and conductance per unit length, which can collectively determine the insertion loss, return loss, and phase response of the channel as functions of frequency. A wireless communication channel comprises a radio frequency propagation path between a transmitting antenna and a receiving antenna, which can be characterized by a channel response that reflects the effects of path loss, multipath propagation, and scattering in the propagation environment. In both cases, channel characteristics are subject to change during operation, In wired channels, the changes can occur from connector deformation, cable flexing, thermal expansion and contraction, and contact oxidation. In wireless channels, the changes can occur from relative motion between communicating devices, changes in the propagation environment, and variation in the impedance characteristics of antenna and radio frequency front-end hardware.

A communication system operating over a communication channel comprises a transmitter and a receiver. In a wired communication system, a transmitter encodes digital data into electrical waveforms and drives those waveforms onto the channel via a line driver or analog front-end circuit, which may include digital-to-analog conversion, pre-emphasis, and output impedance matching circuitry. Correspondingly, a receiver, in the wired communication system, may accept the propagated waveforms via an analog front-end comprising termination, amplification, and filtering stages, and recover the digital data through clock and data recovery (CDR) and equalization processing, where CDR aligns symbol boundaries for sampling and equalization compensates for frequency-dependent loss and inter-symbol interference. In a wireless communication system, a transmitter may encode digital data at a baseband modem and up-convert the resulting baseband signal to a radio frequency carrier via a radio frequency transceiver for transmission over an antenna. Correspondingly, a receiver, in the wireless communication system, may perform the corresponding down-conversion, baseband processing, and data recovery. According to various aspects described herein, in both wired and wireless communication systems, a communication system may include an auxiliary channel over which control information, metadata, or channel state information may be exchanged between communicating devices, implemented as in-band reserved symbols, a physically separate conductor, or an embedded field within a protocol frame.

Physical communication channels introduce impairments to propagating signals that degrade the quality of the received waveform. In wired channels, impedance discontinuities along the channel path generate reflected signal components that distort received symbol shapes. For example, frequency-dependent insertion loss attenuates higher-frequency components more severely than lower-frequency components, producing inter-symbol interference (ISI), and/or crosstalk from adjacent conductors introduces noise correlated with data patterns on neighboring channels. The cumulative effect of these impairments may be degradation of the received eye diagram, which corresponds to the superposition of received waveform traces aligned to symbol timing, manifested as reduced eye opening in both voltage and time dimensions, leading to increased bit error rate (BER). In wireless channels, analogous degradation can arise from multipath propagation, in which signal replicas arriving via different propagation paths with differing delays and attenuations superimpose at the receiver, producing frequency-selective fading and ISI. Doppler frequency shifts arising from relative motion between communicating devices can further distort received symbol timing and phase. To counteract these impairments, communication systems in both contexts may perform a training or calibration procedure during link initialization, which may be through known training sequences in wired systems, or through pilot and reference signal transmission in wireless systems, to determine equalization coefficients and decision thresholds, which are then fixed for the duration of the link session or updated only at slow intervals.

The equalization coefficients, decision thresholds, and encoding parameters determined during initialization reflect the channel state at that point in time and are not continuously updated to account for changes occurring during operation. In wired communication systems, dynamic changes including vibration-induced impedance drift, progressive oxidation of contact interfaces, thermal cycling, and mechanical wear alter the impedance profile in ways that statically configured equalization may not able to track, such that when the channel state deviates from the initialization state, equalization compensation becomes inaccurate and signal margin decreases. In wireless communication systems, channel estimation is performed at intervals determined by pilot signal spacing or measurement reporting cycles, and rapid channel variations arising from device mobility, environmental changes, or antenna impedance shifts may occur between estimation intervals, leaving the receiver operating on a stale channel estimate. In both contexts, the compensation mechanisms employed, which may involve receiver-side equalization in wired systems and channel estimation with link adaptation in wireless systems, are applied after signal transmission has occurred and operate on received waveforms whose geometry was fixed at the transmitter. Neither mechanism can adjust the transmitted symbol shape to reflect the actual channel state at the time of transmission.

Aspects described herein may address the limitation identified above, which may involve that transmitted symbol geometry is fixed at the time of link initialization and cannot adapt to changes in channel conditions occurring during operation. In accordance with various aspects described herein, an apparatus can determine an impedance profile of a communication channel based on a real-time measurement. The apparatus may further select, from a plurality of predefined symbol shapes stored as respective sets of symbol encoding parameters, a set corresponding to the measured impedance profile, encoding digital data using the selected symbol shape. Each transmitted symbol can reflect the recently observed or actual electrical state of the channel at the time of transmission rather than a worst-case or initialization-time model, enabling operation with lower bit error rate and better signal margin at a given data rate and power level.

In various aspects described herein, the impedance profile may be determined repeatedly during transmission, and correspondingly, symbol shape selection may adapt to dynamic changes in channel conditions, including connector wear, cable flexing, and temperature drift in wired channels, and propagation environment variation in wireless channels. In accordance with further aspects described herein, after selecting a symbol shape, an apparatus may apply fine-grained adjustments to the parameters of the selected shape based on the impedance profile, which may be referred to herein as symbol morphing, enabling per-symbol or per-block optimization beyond the resolution of discrete shape selection and counteracting complex impedance profiles or localized reflections that discrete selection alone may not fully address.

Accurate data recovery from dynamically shaped symbols requires that a receiver have knowledge of the symbol encoding parameters applied by the transmitter. In accordance with various aspects described herein, a transmitter may cause transmission of sideband information over an auxiliary channel, the sideband information indicating the impedance profile, an identifier of the selected set of symbol encoding parameters, or both. A corresponding receiver can receive the sideband information and determine, from the sideband information, a set of symbol decoding parameters representative of the time-domain symbol shape used to encode the received signals. In some examples, the receiver can receive the sideband information from the communication channel for transmissions after reception of the sideband information. Based on the symbol decoding parameters, the receiver may generate at least one reference corresponding to the time-domain symbol shape, which may comprise a reference waveform template, a set of decision thresholds, or a set of timing boundaries, and decode received signals using the reference to recover digital data. This receiver-side reconstruction can enable accurate recovery of data encoded with dynamically adapted symbol shapes that deviate from any fixed or predefined standard waveform. The receiver may further update its symbol decoding parameters in response to updated sideband information received during ongoing data reception, enabling the receiver to track transmitter-side adaptations in real time, and may additionally apply the symbol decoding parameters to adjust clock and data recovery parameters and equalization parameters.

In accordance with various aspects described herein, an apparatus may negotiate with a remote apparatus connected via the communication channel to establish availability of impedance-adaptive encoding, the format of sideband information, and the version of the symbol encoding parameter library in use, which can enable interoperability between apparatuses with different capability levels and backward compatibility with devices that do not support impedance-adaptive encoding. When the impedance measurement signal-to-noise ratio falls below a threshold, when a valid impedance measurement is unavailable, or when the sideband error rate exceeds a threshold, an apparatus may revert to a predetermined fixed encoding or decoding scheme, providing an acceptable degradation under degraded measurement or sideband conditions. Because symbol geometry is determined in part by the measured impedance of the communication channel, the symbol shapes in use at any given time are not required to be globally standardized and may not be recovered by a third party without knowledge of the channel impedance and the corresponding encoding parameters, providing an inherent physical-layer property that makes unauthorized signal recovery more difficult without requiring dedicated encryption. By selecting symbol shapes tolerant of reflections, skew, and loss, the aspects described herein extend the usable operating range of marginal or degraded interconnects without modification of the protocol layers above the physical layer. By controlling edge transition rates and spectral content on a per-symbol or per-block basis, these aspects further enable reduction of overshoot, ringing, and high-frequency content that contribute to electromagnetic interference, while maintaining data integrity.

The term “communication channel” may refer to any physical medium or propagation path over which electrical or electromagnetic signals are transmitted between a transmitter and a receiver. In various aspects described herein, the term “communication channel” may further refer to an interconnect between integrated circuits, between discrete devices, or between functional blocks within a single device.

The term “impedance profile” may refer to a characterization of the electrical impedance of a communication channel, which may be expressed as a function of frequency, position along the channel, or time. An impedance profile may comprise at least one of: a differential impedance, a common-mode impedance, a return loss, a reflection coefficient, a frequency-dependent insertion loss, or a crosstalk measure. In various aspects described herein, the term “impedance profile” may further represent a real-time or periodically updated measurement reflecting the current electrical state of the communication channel at the time of measurement.

The term “symbol encoding parameters” may refer to a set of values or coefficients defining how a digital symbol is represented as an electrical waveform for transmission over a communication channel. Symbol encoding parameters may include parameters governing amplitude levels, symbol timing duration, edge transition characteristics, or pre-emphasis applied to the transmitted waveform. The term “time-domain symbol shape” may refer to the voltage-versus-time waveform profile of a single transmitted symbol, defining the waveform geometry that a transmitter produces on a communication channel to represent one or more bits of digital data. A time-domain symbol shape may be characterized by one or more of its edge transition characteristics, its symbol timing duration, and the amplitude levels associated with its logical states. In various aspects described herein, the term “time-domain symbol shape” may further refer to a waveform whose geometry is selectable from a plurality of predefined shapes, each defined by a respective set of symbol encoding parameters, and which may be further adjusted based on measured channel conditions.

The term “edge transition characteristic” may refer to the properties of a voltage transition between symbol states in a transmitted waveform, including a rise time representing the duration of a low-to-high voltage transition and a fall time representing the duration of a high-to-low voltage transition. An edge transition characteristic may further describe the shape of the transition profile, which may, for example, be linear, exponential, or S-curved. The term “amplitude asymmetry” may refer to a difference between the voltage magnitude of a high symbol state and the voltage magnitude of a low symbol state, expressed relative to a reference voltage level, such that the magnitudes of the two states are unequal. In various aspects described herein, the term “amplitude asymmetry” may further refer to an asymmetry deliberately introduced as a symbol encoding parameter, for example to counteract asymmetric channel impairments arising from differential impedance imbalance or asymmetric reflection behavior along the communication channel.

The term “auxiliary channel” may refer to a communication path, separate from or embedded within a primary data communication channel, over which control or metadata information is conveyed between a transmitter and a receiver. An auxiliary channel may be implemented as at least one of: in-band coding within reserved symbol positions of the primary data channel, a physically separate conductor, or an embedded field within a protocol frame. In wireless communication contexts, an auxiliary channel may further comprise a dedicated control channel or reserved sub-band within a wireless frame structure. The term “sideband information” may refer to metadata transmitted via an auxiliary channel that describes properties of a primary data transmission. In various aspects described herein, the term “sideband information” may further indicate at least one of: an impedance profile of the communication channel, or an identifier of a set of symbol encoding parameters used to encode signals transmitted over the primary data channel.

The term “symbol morphing” may refer to a process of applying adjustments to a selected symbol shape based on one or more measured channel parameters, including adjustments to rise time, fall time, amplitude asymmetry, or pre-emphasis. In aspects described herein, symbol morphing can represent a secondary refinement applied after an initial symbol shape selection, operating on the continuous parameters of the selected shape rather than substituting a different discrete shape. The term “pre-emphasis coefficient” may refer to a weighting factor applied to boost or attenuate specific frequency components or edge transitions of a symbol waveform prior to transmission, thereby compensating for anticipated frequency-dependent channel loss. The term “lookup table”, as used herein, may refer to a data structure storing a plurality of sets of symbol encoding parameters, each entry of the lookup table being associated with a respective range of values of an impedance profile, such that a measured impedance profile value may be mapped to a corresponding set of symbol encoding parameters by indexing the table.

The term “reference waveform template” may refer to an expected waveform shape used by a receiver to compare against received symbols for data recovery, representing the waveform that would ideally be received given a known transmitted symbol shape. The term “decision threshold” may refer to a voltage or timing boundary used by a receiver to determine the logical value of a received symbol, where a received signal level on one side of the threshold is interpreted as one logical value and a level on the other side is interpreted as another. In various aspects described herein, decision thresholds may be derived from a set of symbol decoding parameters and may be programmable to reflect the symbol shape in use at a given time. The term “hysteresis” may refer to a condition imposed on parameter switching such that a change in a selected parameter set is withheld unless a measured value deviates from the value associated with the currently selected set by at least a predetermined threshold amount, thereby preventing oscillation between parameter sets under conditions of marginal or noisy measurements.

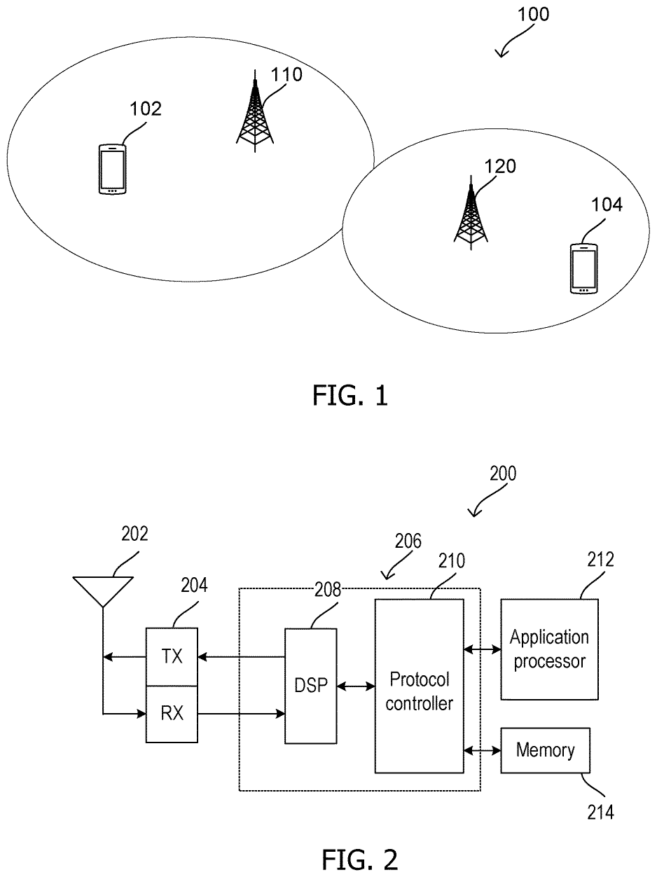

FIGS. 1 and 2 depict a general network and device architecture for communication operations. In particular, FIG. 1 shows exemplary radio communication network 100 according to some aspects, which may include terminal devices 102 and 104 and network access nodes 110 and 120 (e.g. radio access nodes). Radio communication network 100 may communicate with terminal devices 102 and 104 via network access nodes 110 and 120 over a radio access network. Each of terminal devices 102 and 104 or network access nodes 110 and 120 may be a sensing communication device as described herein that may perform a sensing operation. Although certain examples described herein may refer to a particular radio access network context (e.g., 6G, 5G NR, LTE, UMTS, GSM, other 3rd Generation Partnership Project (3GPP) networks, WLAN/Wi-Fi, Bluetooth, mmWave, etc.), these examples are demonstrative and may therefore be readily applied to any other type or configuration of radio access network. The number of network access nodes and terminal devices in radio communication network 100 is exemplary and is scalable to any amount. Although the exemplary architecture is described in a radio communication context, the aspects described herein are equally applicable to wired interconnect communication channels, including but not limited to USB, PCIe, Thunderbolt, DisplayPort, HDMI, MIPI, SATA, and Ethernet interconnects, where communication device may include wired communication interfaces in addition to or instead of the radio communication components described below.

In an exemplary cellular context, network access nodes 110 and 120 may be base stations (e.g., eNodeBs, NodeBs, base transceiver stations (BTSs), gNodeBs, or any other type of base station), while terminal devices 102 and 104 may be cellular terminal devices (e.g., mobile stations (MSs), user equipments (UEs), or any type of cellular terminal device). Network access nodes 110 and 120 may therefore interface (e.g., via backhaul interfaces) with a cellular core network such as an evolved packet core (EPC, for LTE), core network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or Wi-Fi APs), while terminal device 102 and 104 may be short range terminal devices (e.g., stations (STAs)). Network access nodes 110 and 120 may interface (e.g., via an internal or external router) with one or more external data networks. Network access nodes 110 and 120 and terminal devices 102 and 104 may include one or multiple transmission/reception points (TRPs).

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). Furthermore, terminal devices 102 and 104 and network access nodes 110 and 120 may perform a sensing operation, particularly radar sensing, in accordance with joint communication and sensing architecture. In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

In accordance with various aspects described herein, network access nodes 110 and 120 and terminal devices 102 and 104 performing their respective sensing operations in a manner, such that each device may perform its respective sensing operation according to its respective sensing signal configuration. Accordingly, each of these devices may generate and transmit its respective sensing signals according to a respective configuration that may include at least one of frequency resources used to transmit sensing signals, the bandwidth of the sensing signals, transmit power of the sensing signals, and waveform shape of the sensing signals which the respective device may determine before generating and/or transmitting the sensing signals. In some examples, a central orchestrator (e.g., a sensing orchestrator) may determine a respective sensing signal configuration for each device and send information representing the respective sensing signal configuration to the respective device.

The radio access network and core network (if applicable, such as for a cellular context) of radio communication network 100 may be governed by communication protocols that can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include 6G, 5G NR, LTE, UMTS, GSM, WiMAX, Bluetooth, Wi-Fi, mmWave, etc., any of which may be applicable to radio communication network 100.

FIG. 2 shows an exemplary internal configuration of a communication device (e.g., a sensing communication device) according to various aspects provided herein. The communication device may include various aspects of radio communication devices (e.g., network access nodes 110, 120) or various aspects of mobile radio communication devices (e.g., terminal device 102, 104) as well. The communication device 200 may include antenna system 202, radio frequency transceiver 204, baseband modem 206 (including digital signal processor 208 and protocol controller 210), application processor 212, and memory 214. Although not explicitly shown in FIG. 2, in some aspects communication device 200 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Communication device 200 may transmit and receive radio signals on one or more radio access networks. Baseband modem 206 may direct such communication functionality of communication device 200 according to the communication protocols associated with each radio access network, and may execute control over antenna system 202 and radio frequency transceiver 204 to transmit and receive radio signals according to the formatting and scheduling parameters defined by each communication protocol. Although various practical designs may include separate communication components for each supported radio communication technology (e.g., a separate antenna, radio frequency transceiver, digital signal processor, and controller), for purposes of conciseness the configuration of communication device 200 shown in FIG. 2 depicts only a single instance of such components.

Communication device 200 may transmit and receive wireless signals with antenna system 202. Antenna system 202 may be a single antenna or may include one or more antenna arrays that each include multiple antenna elements. For example, antenna system 202 may include an antenna array at the top of communication device 200 and a second antenna array at the bottom of communication device 200. In some aspects, antenna system 202 may additionally include analog antenna combination and/or beamforming circuitry. In the receive (RX) path, radio frequency transceiver 204 may receive analog radio frequency signals from antenna system 202 and perform analog and digital radio frequency front-end processing on the analog radio frequency signals to produce digital baseband samples (e.g., in-phase/quadrature (IQ) samples) to provide to baseband modem 206. Radio frequency transceiver 204 may include analog and digital reception components including amplifiers (e.g., low noise amplifiers (LNAs)), filters, radio frequency demodulators (e.g., RF IQ demodulators), and analog-to-digital converters (ADCs), which radio frequency transceiver 204 may utilize to convert the received radio frequency signals to digital baseband samples. In the transmit (TX) path, radio frequency transceiver 204 may receive digital baseband samples from baseband modem 206 and perform analog and digital radio frequency front-end processing on the digital baseband samples to produce analog radio frequency signals to provide to antenna system 202 for wireless transmission. Radio frequency transceiver 204 may thus include analog and digital transmission components including amplifiers (e.g., power amplifiers (PAs), filters, radio frequency modulators (e.g., RF IQ modulators), and digital-to-analog converters (DACs), which radio frequency transceiver 204 may utilize to mix the digital baseband samples received from baseband modem 206 and produce the analog radio frequency signals for wireless transmission by antenna system 202. In some aspects, baseband modem 206 may control the radio transmission and reception of radio frequency transceiver 204, including specifying the transmit and receive radio frequencies for operation of radio frequency transceiver 204.

In accordance with various aspects provided herein, the communication device 200 may perform sensing operations within the radio communication network 100. Illustratively, the baseband modem 206, (e.g., the digital signal processor 208) may be configured to perform sensing-related signal processing in addition to traditional communication processing. For example, the baseband modem 206 may be configured to implement techniques like radar waveform generation, matched filtering for target detection, parameter estimation (e.g., range, velocity, angle) of detected targets, and environmental mapping. In some examples, the baseband modem 206 (e.g., the digital signal processor 208) may use its hardware accelerators and parallel processing capabilities to efficiently handle the computationally intensive sensing algorithms alongside communication tasks.

Furthermore, the baseband modem 206 (e.g., the protocol controller 210) may be configured to coordinate and/or manage joint operation of communication and sensing functions. Illustratively, the baseband modem 206 may schedule sensing and communication operations, allocate resources (e.g., time/frequency resources, antenna beams) between the sensing operations and the communication operations, and manage interference between them. The baseband modem (e.g., the protocol controller 210) may further implement sensing control protocols and interfaces to enable coordination with other network entities for distributed sensing operations as described herein.

In some examples, the application processor 212 may be configured to act as a source and sink for sensing data, similar to its role for communication data. The application processor 212 may execute sensing applications that are configured to process and interpret the sensing data received from the baseband modem 206. Illustratively, the application processor 212 may perform at least one of object detection and tracking, environmental mapping, and/or situational awareness services using the sensing data. In some examples, the application processor 212 may interface with external sensors (e.g., cameras, lidars) to fuse data from multiple sensing modalities for enhanced perception capabilities.

Correspondingly, the radio frequency transceiver 204 may further support the transmission and reception of sensing waveforms in addition to communication signals. Illustratively, the radio frequency transceiver 204 may generate and transmit sensing signals (e.g., frequency-modulated continuous waveforms for radar), and may process the received sensing signals to extract target information. In some examples, the radio frequency transceiver 204 can use the same analog and digital components (e.g., amplifiers, filters, modulators/demodulators, ADCs/DACs) for sensing operations and the communication operations, potentially with additional hardware accelerators for sensing-specific tasks. Illustratively, the antenna system 202 may also support both communication and sensing functions, in some examples with separate antenna arrays or shared arrays with beamforming capabilities. In accordance with various aspects, the antenna system 202 can form narrow beams for extended sensing range or wide beams for faster coverage, depending on the sensing requirements and resource constraints. Techniques like multiple-input multiple output and beamforming can be employed to enhance the sensing performance and enable features like high-resolution target parameter estimation and interference mitigation.

As shown in FIG. 2, baseband modem 206 may include digital signal processor 208, which may perform physical layer (PHY, layer 1) transmission and reception processing to, in the transmit path, prepare outgoing transmit data provided by protocol controller 210 for transmission via radio frequency transceiver 204, and, in the receive path, prepare incoming received data provided by radio frequency transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or field programmable gate arrays (FPGAs)), software-defined components (e.g., one or more processors configured to execute program code defining arithmetic, control, and I/O instructions (e.g., software and/or firmware) stored in a non-transitory computer-readable storage medium), or as a combination of hardware and software components. In some aspects, digital signal processor 208 may include one or more processors configured to retrieve and execute program code that defines control and processing logic for physical layer processing operations. In some aspects, digital signal processor 208 may execute processing functions with software via the execution of executable instructions. In some aspects, digital signal processor 208 may include one or more dedicated hardware circuits (e.g., application specific integrated circuits (ASICs), field programmable gate arrays, and other hardware) that are digitally configured to specific execute processing functions, where the one or more processors of digital signal processor 208 may offload certain processing tasks to these dedicated hardware circuits, which are known as hardware accelerators. Exemplary hardware accelerators can include fast Fourier transform (FFT) circuits and encoder/decoder circuits. In some aspects, the processor and hardware accelerator components of digital signal processor 208 may be realized as a coupled integrated circuit.

Communication device 200 may be configured to operate according to one or more radio communication technologies. Digital signal processor 208 may be responsible for lower-layer processing functions (e.g., layer 1/PHY) of the radio communication technologies, while protocol controller 210 may be responsible for upper-layer protocol stack functions (e.g., data link layer/layer 2 and/or network layer/layer 3). Protocol controller 210 may thus be responsible for controlling the radio communication components of communication device 200 (antenna system 202, radio frequency transceiver 204, and digital signal processor 208) in accordance with the communication protocols of each supported radio communication technology, and accordingly may represent the access stratum (AS) and non-access stratum (NAS) (also encompassing layer 2 and layer 3) of each supported radio communication technology. Protocol controller 210 may be structurally embodied as a protocol processor configured to execute protocol stack software (retrieved from a controller memory) and subsequently control the radio communication components of communication device 200 to transmit and receive communication signals in accordance with the corresponding protocol stack control logic defined in the protocol software. Protocol controller 210 may include one or more processors configured to retrieve and execute program code that defines the upper-layer protocol stack logic for one or more radio communication technologies, which can include data link layer/layer 2 and network layer/layer 3 functions. Protocol controller 210 may be configured to perform both user-plane and control-plane functions to facilitate the transfer of application layer data to and from radio communication device 200 according to the specific protocols of the supported radio communication technology. User-plane functions can include header compression and encapsulation, security, error checking and correction, channel multiplexing, scheduling, and priority, while control-plane functions may include setup and maintenance of radio bearers. The program code retrieved and executed by protocol controller 210 may include executable instructions that define the logic of such functions.

Communication device 200 may also include application processor 212 and memory 214. Application processor 212 may be a CPU, and may be configured to handle the layers above the protocol stack, including the transport and application layers. Application processor 212 may be configured to execute various applications and/or programs of communication device 200 at an application layer of communication device 200, such as an operating system (OS), a user interface (UI) for supporting user interaction with communication device 200, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to radio frequency transceiver 204. Radio frequency transceiver 204 may then process the digital baseband samples to convert the digital baseband samples to analog radio frequency signals, which radio frequency transceiver 204 may wirelessly transmit via antenna system 202. In the receive path, radio frequency transceiver 204 may receive analog radio frequency signals from antenna system 202 and process the analog radio frequency signals to obtain digital baseband samples. radio frequency transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may embody a memory component of communication device 200, such as a hard drive or another such permanent memory device. Although not explicitly depicted in FIG. 2, the various other components of communication device 200 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select available network access nodes in order to maintain a strong radio access connection with the radio access network of radio communication network 100. For example, terminal device 102 may establish a radio access connection with network access node 110 while terminal device 104 may establish a radio access connection with network access node 120. In the event that the current radio access connection degrades, terminal devices 102 or 104 may seek a new radio access connection with another network access node of radio communication network 100; for example, terminal device 104 may move from the coverage area of network access node 120 into the coverage area of network access node 110. As a result, the radio access connection with network access node 120 may degrade, which terminal device 104 may detect via radio measurements such as signal strength or signal quality measurements of network access node 120. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network protocols and may be employed by terminal devices and the radio access network in order to maintain strong radio access connections between each terminal device and the radio access network across any number of different radio access network scenarios.

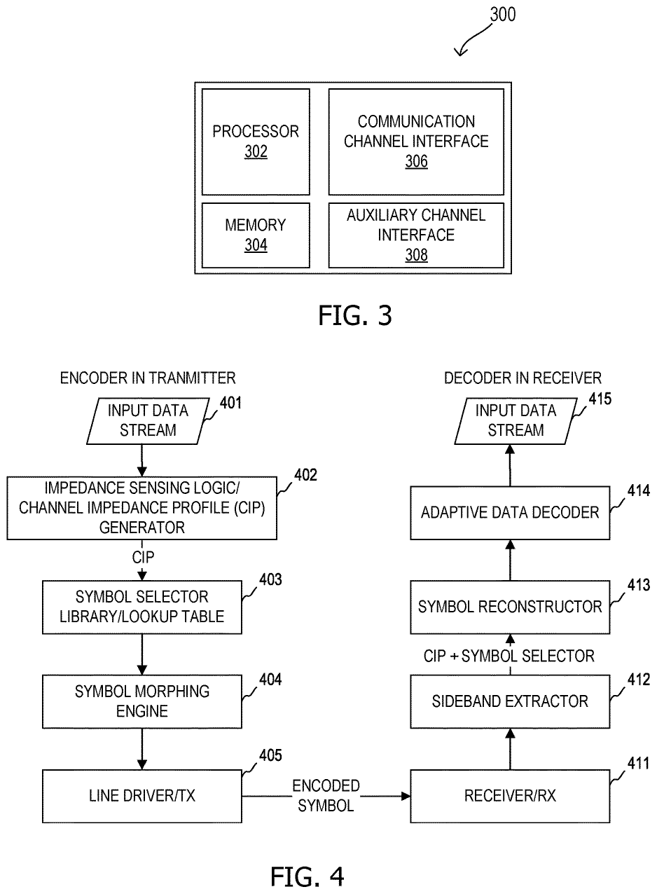

FIG. 3 illustrates an example of an apparatus, which includes processor 302, memory 304, communication channel interface 306, and optionally an auxiliary channel interface 308. The processor 302 and the memory 304 may form the processing and storage subsystem of the apparatus 300, while communication channel interface 306 and auxiliary channel interface 308 may provide the input/output interfaces through which apparatus 300 exchanges signals with external channels. The apparatus 300 may be implemented as a component of communication device 200 of FIG. 2, in which case the processor 302 may correspond to baseband modem 206, digital signal processor 208, protocol controller 210, or application processor 212 of FIG. 2, or may be a dedicated processing unit separate from those components. The apparatus 300 may alternatively be implemented within terminal device 102 or terminal device 104, or within network access node 110 or network access node 120, of radio communication network 100 of FIG. 1. The memory 304 may store program code executable by processor 302 and data structures used in the encoding and decoding operations described herein, including a plurality of sets of symbol encoding parameters each representative of a respective time-domain symbol shape, which may be organized as a lookup table.

The apparatus 300 may operate as a transmitter, as a receiver, or as both. When operating as a transmitter, the processor 302 determines an impedance profile of a communication channel coupled to communication channel interface 306 based on a measurement of the communication channel. The processor 302 may further select a set of symbol encoding parameters from the plurality of sets stored in memory 304 based on the impedance profile, and encode digital data for transmission over the communication channel.

When operating as a receiver, the processor 302 may receive sideband information via auxiliary channel interface 308. The processor 302 may further determine a set of symbol decoding parameters based on the sideband information and generate at least one reference corresponding to the time-domain symbol shape represented by the symbol decoding parameters. The processor 302 may decode received signals using the reference to recover digital data. In a practical wired or wireless communication link, two instances of apparatus 300 may be deployed at respective ends of the communication channel, with one instance operating primarily as a transmitter and the other operating primarily as a receiver, though each instance may be configured with both transmitter and receiver capabilities to support bidirectional data transfer.

The communication channel interface 306 may couple the apparatus 300 to a physical communication channel, which may comprise a differential pair, single-ended conductor, cable assembly, or other physical medium in a wired communication context, or an antenna and radio frequency front-end in a wireless communication context. Auxiliary channel interface 308 may provide the apparatus 300 with access to an auxiliary channel for the exchange of sideband information between communicating devices. In some examples, the auxiliary channel interface 308 and the communication channel interface 306 may share a common physical connection, in which case sideband information may be conveyed as in-band coding within reserved symbol positions or as an embedded field within a protocol frame of the communication channel, without requiring a dedicated physical conductor. The processor 302 may further control a transceiver, which may correspond to radio frequency transceiver 204 of FIG. 2 in a wireless implementation, or a wired transceiver integrated within communication channel interface 306 in a wired implementation, to perform the physical-layer transmission and reception operations associated with the encoding and decoding functions described herein.

The processor 302 may determine an impedance profile of a communication channel based on a measurement of the communication channel. The determination may include causing one or more measurements of the communication channel to be performed via the communication channel interface 306. The processor 302 may process the resulting measurement data, and produce a characterization of the current electrical state of the channel. The impedance profile represents the electrical state of the communication channel at the time of measurement, reflecting channel conditions as they exist during operation rather than as established during link initialization. The processor 302 may derive the impedance profile from a single measurement or from a combination of measurements addressing different channel characteristics, such as differential impedance at a specified frequency, reflection behavior at a connector interface, or frequency-dependent attenuation across the channel bandwidth. The processor 302 may determine the impedance profile once at the start of a transmission session, or may repeatedly determine the impedance profile during ongoing transmission of digital data over the communication channel to track changes in channel conditions over time.

In a more specific example, the processor 302 may determine the impedance profile by causing transmission of a test signal on the communication channel via the communication channel interface 306 and deriving the impedance profile from a response to the test signal. The test signal may comprise a probe signal injected during data transmission, which may have an amplitude below the amplitude of data signals on the communication channel, so as not to disrupt ongoing data transmission, or an idle pattern of the communication channel reused for measurement purposes. In an example, impedance sensing logic within the communication channel interface 306 may inject a low-amplitude probe signal and measure reflections and the channel response to derive a Channel Impedance Profile (CIP). Additionally, or alternatively, the communication channel interface 306 may further comprise analog front-end logic configured to measure differential impedance, common-mode impedance, return loss, and crosstalk between the communication channel and adjacent channels, providing raw measurement data to the processor 302 for processing into the CIP.

The CIP may comprise at least one of: a differential impedance, a common-mode impedance, a return loss, a reflection coefficient, a frequency-dependent insertion loss, or a crosstalk measure. The CIP may be represented as a scalar value, for example an average impedance (Zavg) representing the characteristic impedance of the channel at a representative frequency or an average reflection coefficient (Γavg) representing the magnitude of reflected signal components, as a vector of values representing the impedance as a function of frequency, or as a matrix representing coupling between multiple adjacent channels. A CIP processing engine, which may be implemented in hardware, software, firmware, or a combination thereof within the processor 302 or the communication channel interface 306, may convert raw measurements from the impedance sensing logic into the CIP in a compact, usable form, computing the effective impedance, reflection coefficients, and frequency-dependent loss from the raw measurement data. The CIP processing engine may further apply filtering or smoothing to the raw measurements or to the derived CIP to reduce sensitivity to transient noise in the measurements.

Based on the determined impedance profile, the processor 302 may select a set of symbol encoding parameters from a plurality of sets of symbol encoding parameters stored in the memory 304. Each set of symbol encoding parameters may be representative of a respective time-domain symbol shape. In an example, the selection of the processor 302 maps the measured impedance profile to a predefined set of symbol encoding parameters whose associated time-domain symbol shape is suited to channel conditions characterized by that profile. The plurality of sets may collectively constitute a symbol library representing a range of channel conditions, such that the selection identifies the entry in the library most appropriate for the current channel state, thereby adapting the transmitted symbol geometry to the actual electrical state of the channel at the time of encoding rather than applying a fixed symbol geometry established at link initialization. Each set in the plurality may be associated with a distinct range of impedance profile values, and the processor 302 may identify the applicable set by locating the entry whose associated range encompasses the measured impedance profile.

The plurality of sets of symbol encoding parameters may be stored as entries in a lookup table in the memory 304, each entry being associated with a respective range of values of the impedance profile. The processor 302 may map the measured impedance profile to a corresponding entry by computing Zavg from the CIP and identifying the lookup table entry whose associated impedance range encompasses the computed value, yielding a symbol shape index (k) identifying the selected set. The lookup table may be implemented in firmware as parameter sets describing the symbol shapes, with each entry specifying parameters including rise and fall slopes, amplitude levels, pre-emphasis taps, and edge timing. Control logic within the processor 302 may implement the mapping from the impedance profile to the symbol shape index by comparing Zavg against the boundary values of each entry's associated range. The lookup table may be stored in read-only memory for fixed symbol libraries, or in random-access memory to permit field-updatable libraries loaded via a management interface.

The symbol encoding parameters of at least one of the sets may comprise at least one or a combination of: a rise time, a fall time, an amplitude level, an amplitude asymmetry between a high state and a low state, a pre-emphasis coefficient, an edge timing relative to a clock reference, or a non-linearity parameter of an edge transition profile. The symbol encoding parameters of at least one of the sets may further comprise at least one of: a symbol duration or a number of unit intervals allocated per symbol. The parameters may collectively define the time-domain symbol shape of the respective set. For example, the rise time and fall time determine the rate and profile of voltage transitions between symbol states, which results in governing the spectral content of the waveform. Additionally, or alternatively, the amplitude level and amplitude asymmetry determine the voltage excursions of each logical state. Additionally, or alternatively, the pre-emphasis coefficient specifies the boost or attenuation applied to specific frequency components. Additionally, or alternatively, the symbol duration or unit interval count determines the temporal extent of each transmitted symbol. The processor 302 may provide the selected parameter values to the communication channel interface 306 to configure waveform generation hardware for the current encoding operation.

Each set of symbol encoding parameters described herein is representative of a respective time-domain symbol shape, characterized by at least one or a combination of: an edge transition characteristic including a rise time or a fall time, a symbol timing duration, and an amplitude asymmetry between a high voltage state and a low voltage state. As an example of a symbol library that may be stored in the memory 304, five predefined symbol shapes designated S0 through S4 may be defined for respective channel conditions. Shape S0, a fast-edge NRZ shape, is characterized by sharp rise and fall transitions with minimal shaping, and is suitable for clean channels with low impedance mismatch. Shape S1, a slew-limited NRZ shape, employs slower edge transitions to reduce ringing at the receiver, and is suitable for channels with mild impedance mismatch. Shape S2, a pre-emphasized NRZ shape, boosts high-frequency content to compensate for channel insertion loss, and is suitable for high-loss channels. Shape S3, an asymmetric-edge NRZ shape, employs a rise time that differs from the fall time to counteract reflected signal components, and is suitable for reflection-heavy channels. Shape S4, a curved-edge NRZ shape, employs smooth, curved transitions to reduce inter-symbol interference, and is suitable for channels with severe impedance mismatch.

Based on the selected set of symbol encoding parameters, the processor 302 may encode digital data for transmission over the communication channel. The encoding produces, for each symbol period, an electrical waveform representing one or more bits of the digital data, wherein the electrical waveform exhibits the respective time-domain symbol shape defined by the selected set of symbol encoding parameters. The encoding may encompass any process that converts digital data into an electrical waveform exhibiting the specified time-domain shape on the communication channel. For example, the processor 302 may direct the communication channel interface 306 to generate successive waveform segments, each representing a respective digital symbol value according to the selected symbol encoding parameters, such that the resulting sequence of waveform segments constitutes the encoded digital data stream with each segment reflecting the symbol shape selected based on the impedance profile measured at or near the time of encoding.

The processor 302, or a line driver or waveform generation circuit controlled by the processor 302 within the communication channel interface 306, may generate the electrical waveform representing the digital data on the communication channel. The waveform may exhibit the time-domain shape defined by the selected symbol encoding parameters, for example by configuring programmable edge-shaping drivers of the communication channel interface 306 with the rise time, fall time, amplitude level, and pre-emphasis coefficient specified by the selected set. Programmable edge-shaping drivers may be implemented as multi-tap pre-emphasis circuits, segmented driver circuits in which individual driver segments are enabled or disabled to control output impedance and slew rate, or digitally controlled slew-rate circuits. The communication channel interface 306 may further include timing control circuitry to adjust zero-crossings and edge alignment of the generated waveform relative to a clock reference, in accordance with edge timing parameters of the selected set. An optional digital-to-analog converter within the communication channel interface 306 may provide amplitude resolution beyond binary NRZ levels to support symbol shapes requiring continuous amplitude profiles or multiple amplitude levels.

FIG. 4 illustrates an example of a high-level block diagram of encoder and decoder portions of the apparatus 300. The encoder portion, corresponding to transmitter operation of the apparatus 300, is shown on the left side of FIG. 4 and receives an input data stream 401. The encoder portion comprises an impedance sensing logic/CIP generator 402, a symbol selector library/lookup table 403, a symbol morphing engine 404, and a Line Driver/TX 405. The impedance sensing logic/CIP generator 402 may measure the impedance of the communication channel via the communication channel interface 306 and produce a CIP representing the current electrical state of the channel. The symbol selector library/lookup table 403 may receive the CIP from the impedance sensing logic/CIP generator 402 and, by indexing the lookup table stored in the memory 304, may identify the symbol shape index (k) corresponding to the set of symbol encoding parameters most appropriate for the measured channel conditions. The symbol morphing engine 404 may receive the symbol shape index (k) and apply fine-grained adjustments to the selected parameters based on Zavg and Γavg derived from the CIP, producing a morphed set of symbol encoding parameters. The Line Driver/TX 405 may receive the morphed parameters and encode the input data stream 401 into an encoded symbol for transmission over the communication channel. The CIP and the symbol shape index (k) are additionally provided to the auxiliary channel interface 308 for transmission to the receiver as sideband information.

The decoder portion of the apparatus 300, corresponding to receiver operation, is shown on the right side of FIG. 4 and comprises a Receiver/RX 411, a sideband extractor 412, a symbol reconstructor 413, and an adaptive data decoder 414. The Receiver/RX 411 receives, via the communication channel interface 306, the encoded symbol transmitted by the Line Driver/TX 405 of the remote transmitter-side apparatus over the communication channel. The sideband extractor 412 may receive sideband information via the auxiliary channel interface 308, the sideband information carrying the CIP and the symbol shape index (k) transmitted by the remote transmitter-side apparatus, and extract these parameters for use by the symbol reconstructor 413. The symbol reconstructor 413 may use the extracted CIP and symbol shape index (k) received from the sideband extractor 412 to rebuild the expected symbol shapes, generating reference waveforms, decision boundaries, and timing recovery parameters tuned to the reconstructed shapes. The adaptive data decoder 414 may use the received symbols from the Receiver/RX 411 and the references from the symbol reconstructor 413 to decode the received data, producing a recovered input data stream 415 corresponding to the input data stream 401 encoded by the remote transmitter.

Referring to FIG. 4, the transmitter-side operation of the apparatus 300 may proceed as follows for each symbol period or block of symbol periods. The processor 302 causes the impedance sensing logic/CIP generator 402 to measure the impedance of the communication channel via the communication channel interface 306 and produce a CIP reflecting the current channel state. From the CIP, the processor 302 computes Zavg as a representative impedance value derived from the frequency-dependent measurement data, and Γavg as a representative value of the reflected signal components. Based on the computed Zavg, the processor 302 then causes the symbol selector library/lookup table 403 to identify the symbol shape index (k) by locating the lookup table entry whose associated impedance range encompasses Zavg. The processor 302 then causes the symbol morphing engine 404 to compute morphed symbol encoding parameters as a function of k, Zavg, and Γavg, applying fine-grained adjustments to the parameters of the selected set. The processor 302 then causes the Line Driver/TX 405 to generate the encoded symbol waveform using the morphed parameters and transmit the encoded symbol over the communication channel, and concurrently causes the auxiliary channel interface 308 to transmit sideband information comprising k, Zavg, and Γavg to the remote receiver.

The receiver-side operation of the apparatus 300 may proceed as follows for each symbol period or block corresponding to the transmitter-side operation described above. The processor 302 causes the sideband extractor 412 to receive, via the auxiliary channel interface 308, sideband information comprising the symbol shape index (k), Zavg, and Γavg transmitted by the remote transmitter-side apparatus. From the received k, Zavg, and Γavg, the processor 302 then causes the symbol reconstructor 413 to compute morphed symbol encoding parameters using the same morphing function applied at the transmitter side, thereby reconstructing the parameter set used to generate the transmitted symbol, and to generate a reference symbol from the reconstructed parameters, producing a reference waveform template corresponding to the time-domain shape of the expected received symbol. The processor 302 then causes the Receiver/RX 411 to receive the encoded symbol from the communication channel via the communication channel interface 306, and causes the adaptive data decoder 414 to decode the received symbol by correlating the received waveform against the reference waveform template and selecting the digital data value that produces the highest correlation. The processor 302 outputs the recovered digital data from the adaptive data decoder 414.

When the apparatus 300 operates as a receiver, the communication channel interface 306 receives encoded signals from a communication channel over which a remote transmitter has encoded digital data using a dynamically selected set of symbol encoding parameters. The auxiliary channel interface 308 may receive sideband information from an auxiliary channel, the sideband information indicating at least one of: an impedance profile of the communication channel, or an identifier of a set of symbol encoding parameters used to encode the received signals, which may be represented as the symbol shape index (k). Based on the sideband information received via the auxiliary channel interface 308, the processor 302 may determine a set of symbol decoding parameters representative of a time-domain symbol shape corresponding to the encoding applied by the remote transmitter. The processor 302 may generate at least one reference corresponding to the time-domain symbol shape based on the set of symbol decoding parameters, providing the adaptive data decoder 414 with a basis for comparison against received symbols from the communication channel interface 306. The processor 302 may decode the received signals using the at least one reference to recover digital data, producing an output data stream corresponding to the digital data encoded by the remote transmitter.

It is to be noted that adaptive equalization modifies the receiver's processing of received signals to compensate for channel impairments after transmission. Various aspects described herein modify the transmitted symbol prior to transmission, proactively shaping the waveform to the measured channel state rather than relying on post-reception compensation. Wireless communication systems that perform channel estimation may adjust the modulation and coding scheme based on channel quality indicators; the aspects described herein adjust the time-domain symbol shape based on the measured impedance profile, not the modulation order or coding rate. Encoding schemes such as PAM-4, PAM-3, and QAM vary the number of amplitude or phase levels used to represent digital data; the aspects described herein vary the geometric shape of the symbol waveform (i.e., time-domain symbol shape), including its edge transition characteristics, symbol timing, and amplitude profile, based on real-time impedance measurement, without necessarily altering the number of discrete symbol states. Static pre-emphasis and de-emphasis apply fixed global filter settings established at link initialization. Various aspects described herein adjust symbol parameters (e.g., the symbol encoding parameters) dynamically on a per-symbol or per-block basis in response to continuously updated impedance measurements.

In an example, the processor 302 may determine the impedance profile by causing transmission of a test signal on the communication channel (i.e., via the communication channel interface 306) and deriving the impedance profile from a response to the test signal. Any excitation signal applied to the communication channel that elicits a measurable response reflecting the channel's impedance characteristics may serve as the test signal. For example, the test signal may comprise a probe signal injected during data transmission having an amplitude below the amplitude of data signals on the communication channel. Correspondingly, this operation may enable impedance measurement without interrupting the data stream. Additionally, or alternatively, the test signal may be an idle pattern of the communication channel reused as a measurement stimulus when no data is being transmitted. In a further example, the probe signal may comprise a low-amplitude sinusoidal signal swept across a range of frequencies, a short pulse, or a pseudo-random binary sequence injected in inter-symbol gaps, the response to which the processor 302 may process to extract values including return loss and reflection coefficients characterizing the current electrical state of the communication channel.

As described herein, the impedance profile may comprise at least one of: a differential impedance, a common-mode impedance, a return loss, a reflection coefficient, a frequency-dependent insertion loss, or a crosstalk measure. Any electrical characterization of the communication channel that reflects the channel's current impedance behavior may form part of the impedance profile. For example, the differential impedance may quantify the channel's opposition to differential-mode signal propagation. Illustratively, the common-mode impedance characterizes the channel's response to common-mode signals; the return loss and reflection coefficient quantify signal energy reflected at impedance discontinuities along the channel path; the frequency-dependent insertion loss characterizes the channel's attenuation as a function of frequency; and the crosstalk measure quantifies electromagnetic coupling from adjacent signal conductors. In a further example, the impedance profile may comprise measurements of two or more of these parameters, each evaluated across a plurality of frequencies, providing a more complete impedance profile than a scalar measurement alone.

In an example, the processor 302 may apply at least one of filtering or smoothing to the impedance profile prior to selecting the set of symbol encoding parameters. Any signal conditioning operation that reduces the sensitivity of the impedance profile to transient noise or short-duration variations in the measurement data may constitute filtering or smoothing for the purposes of this example. For example, the processor 302 may apply a low-pass filter to the frequency-domain impedance measurements, or a moving-average filter that computes a running mean of the impedance profile values over a sliding window of successive measurement intervals, to produce a smoothed impedance profile that reflects only sustained changes in channel conditions rather than momentary fluctuations. In a further example, the processor 302 may apply a weighted moving average in which more recent measurements are assigned greater weight than older measurements, with a configurable window length that may be adjusted to the rate at which channel conditions are expected to change in a given deployment. Applying filtering or smoothing before the processor 302 selects the set of symbol encoding parameters prevents transient noise spikes from causing frequent and unnecessary changes in the selected set of symbol encoding parameters.

In an example, the processor 302 may repeatedly determine the impedance profile during transmission of the digital data over the communication channel, to enable the apparatus 300 to track changes in channel conditions as they occur rather than relying on a characterization established at link initialization. This includes use of any process by which the impedance profile is updated more than once during a data transmission session. For example, the processor 302 may determine the impedance profile at regular intervals, with a configurable measurement period that may be set shorter for channels subject to rapid dynamic changes, such as cables in vibrating or thermally cycling environments, and longer for channels in stable operating environments. In a further example, the processor 302 may determine the impedance profile in response to specific triggering conditions, such as a detected degradation in received signal quality or a change in operating temperature, rather than on a fixed schedule. Repeated determination enables the apparatus 300 to continuously adapt symbol encoding parameters to dynamic changes arising from connector wear, cable flexing, progressive contact oxidation, thermal expansion, and mechanical vibration, rather than performing one-time tuning at initialization.

In an example, the CIP processing engine may be implemented as a hardware accelerator within the digital signal processor 208 of FIG. 2, as firmware executing on the protocol controller 210 of FIG. 2, or as a combination of both, in which the hardware accelerator performs computationally intensive operations such as fast Fourier transform-based frequency decomposition and the firmware performs parameter extraction and lookup table indexing. In a wired communication context, the CIP processing engine may receive raw measurement data from the analog front-end logic of the communication channel interface 306, compute the effective impedance, reflection coefficients, and frequency-dependent insertion loss from the raw data, and store the resulting impedance profile in the memory 304 for use by symbol selection logic within the processor 302. In a wireless communication context, the CIP processing engine may receive channel measurement data from a radio frequency measurement path within the communication channel interface 306, computing an effective channel impedance profile from antenna impedance characteristics and radio frequency front-end component measurements. The CIP processing engine may further be realized as field-upgradable firmware, permitting refinement of the measurement processing and computation algorithms over the operational lifetime of the apparatus 300 without modification of the underlying hardware.

In an example, the respective time-domain symbol shape may be characterized by at least one of: an edge transition characteristic including a rise time or a fall time; a symbol timing duration; and an amplitude asymmetry between a high voltage state and a low voltage state. Any geometric property of the voltage-versus-time waveform profile of a transmitted symbol that distinguishes one symbol shape from another may serve as a characterizing parameter of the time-domain symbol shape. For example, the edge transition characteristic, comprising the rise time from low to high voltage state and the fall time from high to low voltage state, governs the slope of the waveform transitions and thereby the spectral content of the transmitted signal. To illustrate, steeper transitions produce greater high-frequency energy, which may counteract high-frequency attenuation in lossy channels, while shallower transitions reduce ringing at impedance discontinuities. The symbol timing duration determines the temporal extent of each symbol period, with longer durations providing greater noise margin for receiver sampling at the expense of effective data rate. The amplitude asymmetry between the high voltage state and the low voltage state, when deliberately introduced as a symbol encoding parameter, may counteract channel impairments that affect the rising and falling transitions of the waveform differently, such as asymmetric impedance mismatch at connector interfaces.

In an example, the plurality of sets of symbol encoding parameters may be stored as entries in a lookup table in the memory 304. Each entry can be associated with a respective range of values of the impedance profile. Any indexed data structure that associates ranges of impedance profile values with corresponding sets of symbol encoding parameters may correspond to the lookup table. For example, the lookup table may comprise a set of entries, each entry identifying a contiguous range of impedance profile values and storing the corresponding set of symbol encoding parameters, such that the processor 302 may select the appropriate set by locating the entry whose associated range encompasses the measured impedance profile value without requiring a search or optimization computation at runtime. In a further example, the lookup table may be resident in firmware as a fixed-size table of N entries, where each entry is indexed by a quantized range of the impedance profile, and the processor 302 may perform the selection by quantizing the measured average impedance (Zavg) to the nearest bin boundary and reading the corresponding entry directly, providing a deterministic, low-latency selection operation suitable for per-symbol adaptation rates.

In an example, the symbol encoding parameters of at least one of the sets may comprise at least one of: a rise time, a fall time, an amplitude level, an amplitude asymmetry between a high state and a low state, a pre-emphasis coefficient, an edge timing relative to a clock reference, or a non-linearity parameter of an edge transition profile. Any numerical value or coefficient that governs the geometry of the transmitted waveform may constitute a symbol encoding parameter within a set. For example, the listed parameters may be combined within a single set to collectively specify a complete time-domain symbol shape. Illustratively, the rise and fall time parameters define the edge transition characteristic; the amplitude level and amplitude asymmetry define the voltage magnitude and relative excursion of each logical state; the pre-emphasis coefficient defines the frequency shaping applied to edge transitions; the edge timing defines the placement of transitions within the symbol period; and the non-linearity parameter defines the curvature profile of the edge transitions, such as a linear, exponential, or S-curved profile. In a further example, a single set may specify a combination of a relatively long rise time, a short fall time, a positive pre-emphasis coefficient, and a non-zero amplitude asymmetry to define a shape of the type described above as S3, the asymmetric-edge NRZ shape, suited to channels exhibiting noticeable impedance mismatch and reflections.

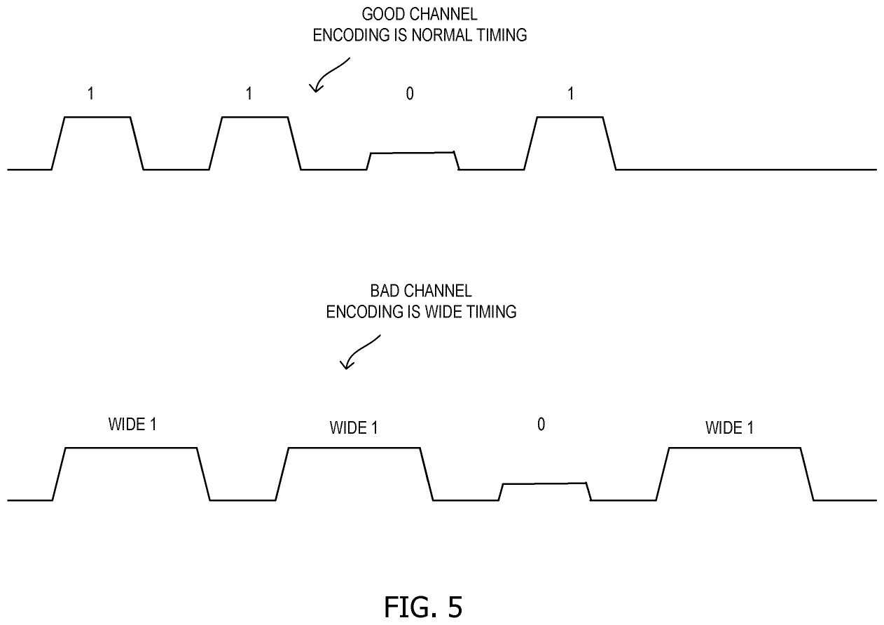

In an example, the symbol encoding parameters of at least one of the sets may comprise at least one of: a symbol duration or a number of unit intervals allocated per symbol. At the broadest level, any parameter that governs the temporal extent of a transmitted symbol, independently of the data value represented, may constitute a symbol duration or unit interval count parameter within a set. For example, the number of unit intervals allocated per symbol may be selected from integer multiples of a base unit interval, such as one, two, or four unit intervals per symbol, with larger values providing greater timing margin for receiver detection and improved noise immunity at the cost of proportionally reduced effective data throughput. The processor 302 may select a set specifying a greater number of unit intervals per symbol when the impedance profile indicates poor channel conditions associated with low signal-to-noise ratio, so that the transmitted symbol occupies a wider time window that a receiver can reliably detect. As illustrated in FIG. 5 and described in the following paragraph, this relationship between channel quality and symbol timing duration can provide a practical mechanism for maintaining reliable data transmission over channels whose impedance profile indicates degraded signal integrity conditions.

FIG. 5 illustrates an example of symbol encoding using variable symbol timing duration. The upper portion of FIG. 5 depicts the encoding of an input data sequence 1, 1, 0, 1 over a good channel using normal symbol timing, in which each logic-one value is encoded as a symbol of a first (e.g., standard) duration and the logic-zero value is likewise encoded at the first duration. The lower portion of FIG. 5 depicts the encoding of the same input data sequence over a bad channel using wide symbol timing, in which each logic-one value is encoded as a symbol occupying a wider time window, labeled WIDE 1 in FIG. 5, while the logic-zero value retains the normal symbol duration. As a further example, a moderately bad channel may cause the processor 302 to select a set of symbol encoding parameters specifying double-wide symbol timing for logic-one values, encoding the input sequence 1, 1, 0, 1 as the sequence 1, 1, 1, 1, 0, 1, 1, in which each logic-one value occupies two unit intervals; and an extremely noisy channel may cause the processor 302 to select a set specifying quadruple-wide timing, encoding the same input as the sequence 1, 1, 1, 1, 1, 1, 1, 1, 0, 1, 1, 1, 1, in which each logic-one value occupies four unit intervals to provide the maximum timing margin for reliable receiver detection.

In an example, the processor 302 may select the set of symbol encoding parameters at a granularity of one of: per transmitted symbol, or per block of transmitted symbols. Any temporal unit at which the processor 302 may independently select a set of symbol encoding parameters constitutes a selection granularity. In an example, the processor 302 may perform the selection on a per-symbol basis, in which the processor 302 re-evaluates the impedance profile and selects a potentially different set for each individual symbol period, to provide maximum responsiveness to rapid or bursty changes in channel conditions and enabling fine-grained optimization for pattern-dependent impairments, at the cost of higher measurement and computation frequency. Alternatively, the processor 302 may perform the selection on a per-block basis, applying the same selected set of symbol encoding parameters to a contiguous block of N transmitted symbols, which can reduce the overhead associated with impedance measurement and selection while still adapting to changes that persist over multiple symbol periods. In a further example, per-symbol selection may be applied when the impedance profile is changing rapidly, such as during active mechanical disturbance of a cable, while per-block selection may be applied when the channel is relatively stable, with the block size N configurable as a function of the estimated rate of change of the impedance profile. Per-block selection additionally reduces the rate at which sideband information must be updated and transmitted over the auxiliary channel.

In an example, after selecting the set of symbol encoding parameters, the processor 302 may adjust at least one parameter of the selected set based on the impedance profile, and encode the digital data in accordance with the adjusted set of symbol encoding parameters. The processor 302 may perform the adjustment to one or more parameters of the selected set after an initial selection step, using current values from the impedance profile. For example, the processor 302 may adjust the rise time, fall time, amplitude asymmetry, or pre-emphasis coefficient of the selected set based on the average impedance (Zavg) and the average reflection coefficient (Γavg) derived from the impedance profile, applying continuous fine-grained corrections to the discrete parameters of the selected symbol shape that a lookup table entry alone cannot resolve. A first processing of discrete selection followed by a second processing of continuous adjustment can enable the symbol shape to be tailored both to the general impedance range of the channel and to the specific measured channel state within that range. In a further example, the processor 302 may compute adjusted parameters as a function of (i.e., based on) the symbol shape index (k), Zavg, and Γavg, illustratively by increasing the rise time when Γavg indicates greater-than-expected reflections, decreasing the fall time correspondingly, and/or boosting the pre-emphasis coefficient when Zavg indicates greater-than-expected insertion loss.

The parameter adjustments performed by the processor 302 may be implemented by circuits within the communication channel interface 306 that accept dynamically updated parameter values from the processor 302 at each symbol period or block boundary. The processor 302 may cause adjustment of rise time and fall time via programmable slew-rate circuitry that reconfigures between symbol periods based on updated values. The processor 302 may cause the adjustment of the pre-emphasis coefficient via reconfigurable multi-tap filter weights applied to waveform edge transitions. The processor 302 may cause the adjustment of amplitude asymmetry via a digital-to-analog converter that sets the output voltage levels to the adjusted high and low state targets. In a wired communication context, this adjustment circuitry may be integrated within a line driver of the communication channel interface 306. In a wireless communication context, equivalent capability may be integrated within a line driver of radio frequency transceiver 204 of FIG. 2. The adjusted symbol encoding parameters computed by the processor 302 as a function of k, Zavg, and Γavg are provided to the respective adjustment circuits prior to each encoding operation, such that the encoded waveform reflects both the discrete symbol shape selected from the lookup table and the continuous adjustments derived from the measured impedance profile.

In an example, the processor 302 may encode the digital data by generating an electrical waveform representing the digital data on the communication channel, wherein the electrical waveform exhibits the respective time-domain symbol shape represented by the selected set of symbol encoding parameters. Generating the electrical waveform may encompass any process by which the processor 302, or circuitry controlled by the processor 302, produces a voltage or current signal on the communication channel whose time-domain profile corresponds to the selected symbol shape. For example, the processor 302 may cause the communication channel interface 306 to produce a voltage waveform on a differential pair or single-ended conductor of the communication channel, wherein the waveform's rising and falling edge transitions, amplitude levels, and pre-emphasis match the parameters of the selected set, making the waveform physically observable at the terminals of the communication channel with the corresponding time-domain symbol shape. In a further example, the processor 302 may cause a segmented driver within the communication channel interface 306 to generate the waveform, with individual driver segments enabled or disabled in a time-varying pattern that realizes the rise time, fall time, and amplitude profile specified by the selected set, and with pre-emphasis taps adjusted independently to shape the frequency content of the waveform edges.

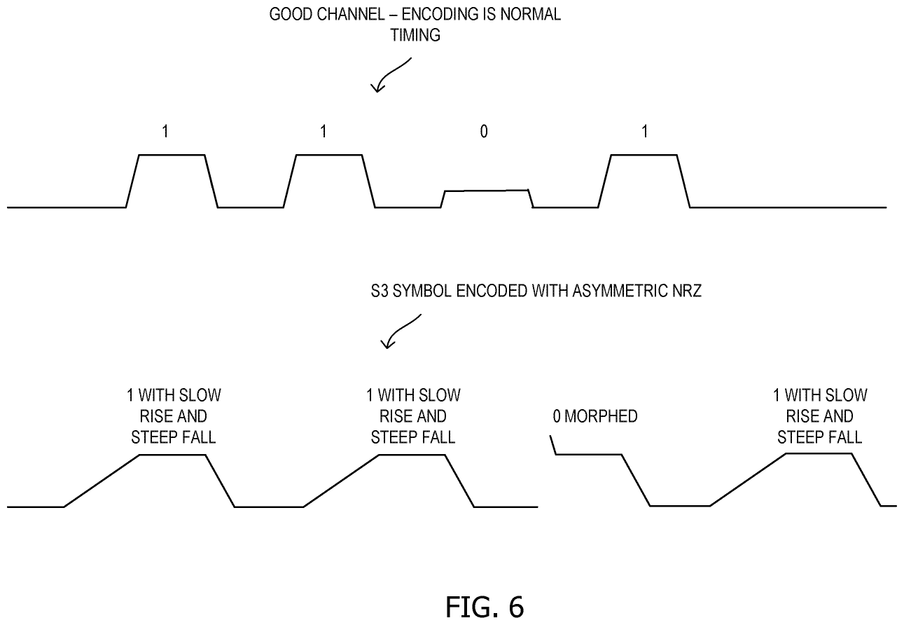

FIG. 6 illustrates an example of symbol encoding using the S3 asymmetric-edge NRZ shape, resulting from symbol selection and parameter adjustment based on an impedance profile indicating moderate impedance mismatch with noticeable reflected signal components. The upper portion of FIG. 6 depicts the encoding of an input data sequence 1, 1, 0, 1 over a good channel using normal symbol timing, with symmetric rise and fall transitions of equal duration, corresponding to a symbol shape selected when the impedance profile indicates clean channel conditions. The lower portion of FIG. 6 depicts the encoding of the same input data sequence using the S3 symbol shape, in which the impedance profile measurement indicating moderate mismatch and noticeable reflections leads the processor 302 to select S3 and apply morphing adjustments including slower edges and increased pre-emphasis. As shown in FIG. 6, each logic-one value is encoded with a slow rise transition and a steep fall transition, labeled ‘1 WITH SLOW RISE AND STEEP FALL’ in FIG. 6, reflecting the asymmetric edge transition characteristic of S3 in which the rise time is substantially longer than the fall time. The logic-zero value is encoded with a morphed transition profile, labeled ‘0 MORPHED’ in FIG. 6, in which the edge transitions have been adjusted based on Zavg and Γavg to counteract the asymmetric reflection behavior of the communication channel. The slow rise transition limits the high-frequency spectral energy that would generate amplified reflections at impedance discontinuities, while the steep fall transition preserves sharp timing reference points for receiver clock recovery.

In an example, the processor 302 may cause transmission of sideband information over an auxiliary channel, the sideband information indicating at least one of: the impedance profile, or an identifier of the selected set of symbol encoding parameters. Any metadata conveyed over a low-rate communication path that enables a receiver to determine the channel state or the encoding parameters applied by the transmitter may correspond to the sideband information for the purposes of this example. For example, the sideband information may indicate the impedance profile by including the values of Zavg and Γavg derived from the CIP, indicate the identifier of the selected set of symbol encoding parameters by including the symbol shape index (k), or include both, enabling the receiver to reconstruct the time-domain symbol shape used for encoding and generate the references required for decoding. In a further example, the processor 302 may cause the auxiliary channel interface 308 to transmit a compact sideband message comprising k, Zavg, and Γavg once per symbol period or once per block of symbol periods, with firmware logic within the processor 302 assembling the message and scheduling its transmission over the auxiliary channel concurrently with data transmission over the communication channel.

In an example, the auxiliary channel may comprise at least one of: in-band coding within reserved symbol positions of the communication channel, a physically separate conductor, or an embedded field within a protocol frame of the communication channel. Any physical or logical mechanism by which a low-rate metadata signal may be conveyed alongside the primary data transmission may constitute an auxiliary channel for the purposes of this example. For example, the in-band coding approach, the processor 301 encodes the sideband information into symbol positions reserved within the primary data stream, such as control characters or idle symbols, allowing the sideband information to share the physical transmission medium of the communication channel without occupying a dedicated conductor. Alternatively, in the physically separate conductor approach, the processor 302 may cause the sideband information to be transmitted by a dedicated wire or trace that carries the sideband information. In an example, the this physically separate conductor may be designated only for transmitting the sideband information. In the embedded field approach, the processor 302 may place sideband information in a defined field within the framing structure of the communication channel protocol. In a further example, the in-band coding approach may use K-codes or ordered sets defined within the framing layer of an existing wired interconnect standard to carry the sideband message, reusing existing low-rate capacity already present in the protocol without requiring additional physical resources.

In an example, the auxiliary channel interface 308 and the communication channel interface 306 may share a common physical connection, and the sideband information may be received as at least one of: in-band coding within reserved symbol positions, or an embedded field within a protocol frame. This example includes any arrangement in which sideband signaling is multiplexed onto the same physical medium as the primary data transmission without a dedicated separate conductor. For example, the sideband information may be multiplexed onto the shared physical connection using time-division techniques, in which reserved symbol positions within the data stream are allocated to carry sideband information at defined intervals, or using code-division techniques, in which specific code patterns or control symbols within the data stream are assigned to carry sideband content. In a further example, the sideband information may be carried in a reserved symbol position occurring at a defined interval, such as a control symbol inserted once per block of data symbols, or in a dedicated field appended to each protocol frame, enabling the receiver to locate and extract the sideband content using the framing structure of the communication channel without additional hardware beyond the communication channel interface 306.

The sideband information may be transmitted at a rate sufficient to enable the receiver to track changes in the impedance profile and the selected set of symbol encoding parameters during data transmission. This rate may be substantially lower than the primary data rate to minimize the overhead imposed on the auxiliary channel or the reserved symbol positions allocated to sideband content. The sideband update rate may be matched to the rate at which the processor 302 determines the impedance profile, which is configurable based on the expected rate of change of the channel conditions. For example, the processor 302 may apply a higher update rate when channel conditions are changing rapidly. Correspondingly, the processor 302 may apply a lower update rate when the channel is stable. A format for the sideband information, including the representation of impedance profile values such as Zavg and Γavg, the resolution at which these values are encoded in the sideband message, and the sideband update rate, may be established by negotiation between the communicating apparatuses during a link training phase, so that both sides maintain a consistent interpretation of the sideband content. Parameters that may be negotiated include the resolution of the channel impedance profile representation, the sideband update rate, and the version of the symbol encoding parameter library in use.

In an example, the at least one reference may comprise at least one of: a reference waveform template, a set of decision thresholds, or a set of timing boundaries for symbol detection. The at least one reference may include any representation of an expected received signal against which an actual received symbol may be compared for the purpose of data recovery. For example, a reference waveform template represents the expected voltage-versus-time profile of a received symbol given the time-domain symbol shape determined from the sideband information, providing a waveform against which the received symbol may be compared via correlation. A set of decision thresholds may represent the voltage boundaries used to determine the logical value of a received symbol based on its sampled amplitude and a set of timing boundaries for symbol detection may define the time windows within which transitions and amplitude samples of the received symbol are expected to occur, based on the symbol timing duration and edge transition characteristic of the reconstructed symbol shape. In a further example, the processor 302 may generate a complete set comprising the reference waveform template, the set of decision thresholds, and the set of timing boundaries together, each derived from the morphed symbol encoding parameters computed from the sideband information, providing the adaptive data decoder 414 with a fully specified expected symbol profile against which received symbols are compared.

In an example, decoding the received signals may comprise correlating each received symbol with the at least one reference to determine a most likely value of the digital data represented by the received symbol. The correlation-based decoding may include any comparison-based decoding process in which a received symbol is evaluated against one or more expected signal representations to identify the most likely transmitted data value. For example, the processor 302 may cause the adaptive data decoder 414 to compute a correlation metric between the received waveform of each symbol and the reference waveform template, quantifying the degree of similarity between the received symbol and the expected symbol shape. The processor 302 may then select the digital data value whose associated reference waveform template produces the highest correlation metric as the output. In a further example, the correlation computation may operate on sampled versions of the received waveform and the reference waveform template, computing an inner product or normalized cross-correlation over the symbol period to produce a scalar similarity score for each candidate data value, with the candidate producing the maximum score selected as the recovered value, corresponding to the operation of selecting the digital data value most consistent with the received symbol under the reconstructed symbol shape.

In an example, the processor 302 may update the set of symbol decoding parameters in response to updated sideband information received via the auxiliary channel interface 308 during reception of the encoded signals. The update of the set of symbol decoding parameters may include any process by which the processor 302 modifies the set of symbol decoding parameters based on sideband information received after decoding has commenced. For example, the processor 302 may monitor the auxiliary channel interface 308 for incoming sideband messages during ongoing data reception, and upon receiving an updated sideband message carrying a new symbol shape index (k), an updated average impedance (Zavg), or an updated average reflection coefficient (Γavg), update the set of symbol decoding parameters accordingly before processing the next received symbol or block of received symbols. In a further example, upon receiving an updated sideband message, the processor 302 may recompute the morphed symbol encoding parameters as a function of the updated k, Zavg, and Γavg, regenerate the at least one reference from the recomputed parameters, and supply the updated reference to the adaptive data decoder 414, enabling the receiver to track transmitter-side symbol shape changes in real time without interrupting data reception.

In an example, the processor 302 may adjust at least one of a clock recovery parameter or an equalization parameter based on the set of symbol decoding parameters. This adjustment can include any modification of a parameter governing clock recovery or equalization processing that is informed by the reconstructed symbol shape. The processor 302 may use edge transition timing information from the set of symbol decoding parameters, specifically the rise time, fall time, and edge timing relative to a clock reference, to configure clock recovery circuitry to anticipate transitions at the correct positions within the symbol period. The processor 302 may further may use frequency response information derived from the pre-emphasis coefficient and amplitude levels of the set of symbol decoding parameters to configure equalization to compensate for the known frequency shaping of the transmitted symbol. In a further example, the processor 302 may supply the set of symbol decoding parameters to existing clock and data recovery and equalization blocks within the communication channel interface 306 or the digital signal processor 208 of FIG. 2, providing these blocks with symbol shape-specific parameter values rather than relying on static values established at link initialization, so that clock recovery and equalization settings track the dynamically adapted symbol shapes transmitted by the remote apparatus.

In an example, the processor 302 may decode the received signals using at least one of: a slicer with programmable thresholds derived from the set of symbol decoding parameters, or a detector that performs maximum-likelihood or near-maximum-likelihood detection using the at least one reference as a template. A slicer or a detector may correspond to application of a detection mechanism that uses the reconstructed symbol shape information to determine the logical value of a received symbol. For example, the slicer approach uses one or more voltage comparators whose threshold levels are derived from the amplitude levels and amplitude asymmetry specified by the set of symbol decoding parameters, such that the slicer correctly classifies the received symbol voltage into a logical state using thresholds matched to the dynamically adapted symbol shape. Additionally, or alternatively, the detector approach uses the reference waveform template as a pattern against which the received waveform is matched to identify the most likely transmitted data value according to a maximum-likelihood or near-maximum-likelihood criterion. In a further example, the detector may be implemented as a Viterbi-based decoder or a DSP-based correlator that operates on reconstructed symbol templates derived from the set of symbol decoding parameters, yielding improved tolerance to channel noise relative to a fixed-threshold slicer when symbol shapes deviate substantially from standard NRZ geometry.

The symbol reconstructor 413 of FIG. 4 may be implemented as a hardware block within the digital signal processor 208 of FIG. 2, as firmware executing on the protocol controller 210 of FIG. 2, or as a combination of both, in which the hardware block performs computationally intensive operations such as waveform template generation and the firmware performs parameter extraction and reference management. The symbol reconstructor 413 may receive the CIP and the symbol shape index (k) from the sideband extractor 412 and rebuild the expected symbol shapes by applying the same morphing function applied at the transmitter side. From the rebuilt symbol shapes, the symbol reconstructor 413 may generate a reference waveform template for each symbol type, derive a set of decision thresholds corresponding to the amplitude levels of the rebuilt symbol shapes, and derive a set of timing boundaries for symbol detection corresponding to the expected transition positions and sample windows of the rebuilt symbol shapes. The resulting references and the symbol decoding parameters may be provided to the adaptive data decoder 414 and, where applicable, to the clock and data recovery and equalization circuitry, enabling these components to operate with parameters specifically matched to the current symbol shape. The symbol reconstructor 413 may be updated via field-upgradable firmware in the protocol controller 210 of FIG. 2, permitting refinement of the shape reconstruction algorithms over the operational lifetime of the apparatus 300.

In an example, the processor 302 may select a different set of symbol encoding parameters from the plurality of sets in response to a change in the impedance profile. A different set selection may include any re-evaluation of the symbol shape selection triggered by a measured change in the impedance profile that results in a different set being identified as most appropriate for the current channel state. When the processor 302 determines a new impedance profile during ongoing data transmission and the newly computed average impedance (Zavg) maps to a different entry in the lookup table than the entry associated with the currently selected set, the processor 302 may select the set associated with the new entry, replacing the previously selected set with one whose time-domain symbol shape is better suited to the updated channel conditions. In a further example, a channel subject to mechanical disturbance or thermal variation may exhibit a Zavg value that migrates across a boundary between two adjacent lookup table entries over time; each time such a migration is detected, the processor 302 selects the set of symbol encoding parameters associated with the entry now encompassing the measured Zavg, continuously adapting the transmitted symbol shape to the evolving impedance profile.

In various aspects described herein, the processor 302 may apply a hysteresis condition to the selection of a different set of symbol encoding parameters, such that a change in the selected set is withheld unless the impedance profile deviates from a value associated with the currently selected set by at least a predetermined threshold. This hysteresis application may include any mechanism that prevents the processor 302 from selecting a different set of symbol encoding parameters until a measured change in the impedance profile exceeds a specified magnitude. The processor 302 may compare the current Zavg against the boundaries of the impedance range associated with the currently selected lookup table entry and withhold a change in selection unless Zavg has deviated from a reference value associated with the currently selected entry by an amount exceeding the predetermined threshold, preventing frequent selection changes when the impedance profile fluctuates near an entry boundary due to measurement noise or minor channel variation. In a further example, the hysteresis condition may be implemented as a dead-band region surrounding each entry boundary in the lookup table, within which a measured Zavg does not trigger a selection change regardless of which side of a nominal boundary it falls on, with the width of the dead-band region configurable as a function of the expected measurement noise level.

An adaptation rate at which the processor 302 responds to changes in the impedance profile by updating the selected set of symbol encoding parameters may be configured to reflect the expected rate of change of channel conditions in a given deployment context. A more aggressive adaptation rate, in which the processor 302 evaluates the impedance profile and updates the symbol shape selection at every symbol period or at short block intervals, may be appropriate for channels subject to rapid impedance variation; a more conservative adaptation rate, in which updates are performed at longer intervals, may be appropriate for channels in stable operating environments. Firmware APIs within the processor 302 may expose configuration parameters governing symbol library contents, hysteresis thresholds, and adaptation aggressiveness, enabling an operator or host system to tune the adaptation behavior to the specific deployment environment without modification of the underlying hardware. Field-upgradable microcode within the processor 302 may further permit refinement of adaptation algorithms, including the impedance profile determination logic, the symbol shape selection and morphing computation, and the hysteresis implementation, over the operational lifetime of the apparatus 300, allowing improvements to be deployed in the field as the operational characteristics of the communication channel become better understood.

In various aspects described herein, the processor 302 may negotiate with a remote apparatus connected via the communication channel to establish at least one of: availability of impedance-adaptive encoding, a format of sideband information, or a version of the plurality of sets of symbol encoding parameters. The negotiation may comprise any link-level capability exchange through which apparatus 300 and the remote apparatus determine whether both ends can support dynamically selected time-domain symbol shapes and corresponding receiver reconstruction. For example, during a link training phase, the processor 302 may cause the communication channel interface 306 or the auxiliary channel interface 308 to exchange capability fields indicating whether impedance-adaptive encoding is supported, which format of sideband information is to be used, and which version of the plurality of sets of symbol encoding parameters is available in the memory 304. In a further example, an extended training sequence may include fields specifying an impedance profile resolution, a sideband update rate, a symbol shape index size, and an identifier of a symbol library version (i.e., version of the plurality of sets of symbol encoding parameters), enabling both ends of the communication channel to apply the same interpretation to subsequent sideband information and selected symbol encoding parameters.

In an example, the processor 302 may negotiate with a remote apparatus connected via the communication channel to establish at least one of: availability of impedance-adaptive encoding, a format of the sideband information, or a version of a plurality of sets of symbol encoding parameters. The receiver-side negotiation may include participation in the same link training phase described for transmitter operation. The negotiation may further include that whether the receiver can receive sideband information, determine the set of symbol decoding parameters, generate the at least one reference, and decode received signals based on the negotiated symbol library version. For example, the processor 302 may receive a capability indication from the remote apparatus identifying a proposed version of the plurality of sets of symbol encoding parameters and may respond with an acknowledgement when the memory 304 stores a compatible version or when the processor 302 can translate the proposed version into locally supported symbol decoding parameters. In a further example, the processor 302 may negotiate whether the sideband information will carry the impedance profile directly, the symbol shape index (k), or a compact combination of k, Zavg, and Γavg.

In various aspects described herein, the processor 302 may revert to a predetermined fixed encoding scheme when at least one of the following conditions is met: a signal-to-noise ratio of the impedance measurement falls below a threshold, a valid impedance measurement is unavailable, or an error rate in the sideband information exceeds a threshold. Reverting to the predetermined fixed encoding scheme may include any controlled transition from impedance-adaptive encoding to an encoding mode whose symbol encoding parameters are not selected based on the current impedance profile. For example, when the measurement of the communication channel is too noisy to produce a reliable impedance profile, the processor 302 may stop selecting a set of symbol encoding parameters based on Zavg and instead configure the communication channel interface 306 for a predefined encoding mode (e.g., fixed NRZ or PAM encoding mode) supported by the communication protocol. In a further example, when the sideband information error rate exceeds a threshold indicating that the receiver may not reconstruct the selected time-domain symbol shape reliably, the processor 302 may switch to a predefined (e.g., standard NRZ mode) with predetermined static pre-emphasis, and may notify the remote apparatus of the fallback condition during link training or by using a reserved protocol field.

In an example, when operating as a receiver, the processor 302 may revert to a predetermined fixed decoding scheme when the sideband information is absent or does not satisfy a reliability criterion. The predetermined fixed decoding scheme may correspond to a legacy encoding scheme of the communication channel, such as a fixed NRZ decoding mode, a fixed PAM decoding mode, or another protocol-defined physical-layer decoding mode. For example, when the auxiliary channel interface 308 does not receive sideband information within an expected interval, or when the sideband information fails a cyclic redundancy check, parity check, sequence-number check, or consistency check against an expected symbol library version, the processor 302 may stop updating the set of symbol decoding parameters and may configure the adaptive data decoder 414 for fixed-threshold or fixed-template decoding. In a further example, the processor 302 may cause clock and data recovery circuitry and equalization circuitry to use default parameters associated with the predetermined fixed decoding scheme, so that the receiver remains compatible with a remote apparatus that transmits using a legacy encoding scheme or temporarily suspends impedance-adaptive encoding.

In some aspects, the processor 302 may perform automatic detection of whether the remote apparatus connected via the communication channel supports impedance-adaptive encoding and may enable or disable impedance-adaptive encoding based on the detection result. Automatic detection may be performed during a link training phase by monitoring capability fields, reserved ordered sets, protocol frame fields, auxiliary channel messages, or other training indicators transmitted by the remote apparatus. For example, when the processor 302 detects a valid capability indication identifying support for impedance-adaptive encoding, a compatible format of sideband information, and a compatible version of the plurality of sets of symbol encoding parameters, the processor 302 may enable impedance profile measurement, symbol selection, symbol morphing, and sideband information exchange for the communication session. Conversely, when the processor 302 does not detect such support, the processor 302 may configure the apparatus 300 to operate using the predetermined fixed encoding scheme or the predetermined fixed decoding scheme. The automatic detection and switching may permit apparatus 300 to communicate with both impedance-adaptive peers and legacy devices without requiring a change to protocol layers above the physical layer.

In an example, the processor 302 may control a transceiver to perform transmission or reception over the communication channel. The transceiver may include any physical-layer circuitry that converts encoded digital data, digital samples, or control signals from the processor 302 into signals applied to the communication channel, or that converts received signals from the communication channel into samples or symbols for processing by the processor 302. In a wireless communication context, the transceiver may correspond to the radio frequency transceiver 204 of FIG. 2, and the processor 302 may provide digital baseband samples, symbol encoding parameters, timing control values, amplitude control values, or pre-emphasis control values to the radio frequency transceiver 204 for conversion into analog radio frequency signals transmitted via the antenna system 202. In a wired communication context, the transceiver may be integrated within the communication channel interface 306 and may comprise a line driver, receiver front-end, digital-to-analog converter, analog-to-digital converter, termination circuitry, clock and data recovery circuitry, or equalization circuitry. In a further example, the processor 302 may provide the selected set of symbol encoding parameters, or an adjusted set of symbol encoding parameters, to a digital-to-analog converter and line driver within the transceiver, so that the transceiver generates the electrical waveform exhibiting the respective time-domain symbol shape for transmission over the communication channel.

In various aspects described herein, the processor 302 may generate telemetry data comprising at least one of: a history of impedance profile values recorded during transmission, a frequency of symbol set changes, or a symbol error rate associated with each set of symbol encoding parameters. The processor 302 may further make the telemetry data available via a management interface. The telemetry data may include any operational information that characterizes how the apparatus 300 adapts transmission to the communication channel during use. For example, the processor 302 may store a time series of impedance profile values in the memory 304. The processor 302 may further maintain a counter indicating how often the selected set of symbol encoding parameters changes within a measurement window, and accumulate symbol error statistics for each selected set. In a further example, diagnostics and telemetry logic implemented by the processor 302 may report impedance profile statistics, symbol error rates, and adaptation behavior for debugging and field monitoring. The management interface may comprise a register interface, firmware API, service channel, diagnostic port, or host-readable memory region through which a host system or service tool reads the telemetry data without interrupting data transmission over the communication channel.

The processor 302 may detect degradation of the communication channel by identifying a monotonic trend in the impedance profile over a plurality of successive measurement intervals. The processor 302 may then generate an alert when the trend exceeds a degradation threshold. Trend-based degradation detection may include any process that distinguishes sustained movement of the impedance profile from short-duration measurement noise. For example, the processor 302 may evaluate stored history of impedance profile values and determine whether Zavg, return loss, reflection coefficient, or frequency-dependent insertion loss changes in a substantially one-directional manner across successive measurement intervals. For example, a monotonic increase in reflection coefficient or a monotonic decrease in return loss may indicate progressive connector wear, contact oxidation, cable damage, or mechanical deformation of the communication channel. In a further example, the processor 302 may apply regression over a sliding window of N impedance profile measurements and compare the resulting slope with the degradation threshold. When the slope exceeds the degradation threshold, the processor 302 may generate an alert by setting a status bit, raising an interrupt, writing an event record to the memory 304, or transmitting a diagnostic message via the management interface.

The management interface, as described herein, may further expose diagnostics and configuration parameters associated with impedance-adaptive operation of the apparatus 300. The exposed parameters may include one or a combination of: lookup table contents, symbol library identifiers (i.e., the identifiers of versions of the plurality of sets of symbol encoding parameters), measurement intervals, smoothing filter coefficients, hysteresis thresholds, degradation thresholds, sideband information update intervals, and adaptation aggressiveness values. The processor 302 may use these parameters to configure the operation of the impedance profile measurement logic, the selection of the set of symbol encoding parameters, the adjustment of the selected set, and the generation of the telemetry data. For example, a service tool may read the history of impedance profile values and the frequency of symbol set changes to determine whether a cable or connector is approaching a service limit, while a firmware component may adjust an adaptation aggressiveness value to reduce selection changes on a stable channel. In a further example, field-upgradable microcode executed by the processor 302 may refine diagnostics algorithms over time, including the computation of impedance profile statistics, the association of symbol error rate with each set of symbol encoding parameters, and the criteria used to identify long-term impedance trends indicative of failing cables or connectors.

The aspects described herein may provide a physical-layer security property arising from channel-dependent symbol formation. Because a time-domain symbol shape may be selected based on a measured impedance profile and may further be adjusted based on impedance-derived parameters, a signal observed at the communication channel may not correspond to a fixed standardized symbol geometry. A third party tapping the communication channel without access to the sideband information, the applicable version of the plurality of sets of symbol encoding parameters, and the morphing relationship used by the processor 302 would not readily determine the time-domain symbol shape represented by a received waveform. The sideband information and the impedance profile may therefore form part of the practical information needed to reconstruct the at least one reference used for decoding. This property may be used in secure peripheral connections, digital rights management interfaces, anti-tamper communication paths, device authentication links, or other systems in which physical observation of a communication channel should not by itself provide enough information to recover digital data using standard receiver tools.

Additionally, or alternatively, the aspects described herein may assist coexistence with electromagnetic interference and electromagnetic compatibility constraints by controlling edge transition characteristics and spectral content in view of the impedance profile. The processor 302 may select a set of symbol encoding parameters that changes rise time, fall time, pre-emphasis coefficient, symbol timing duration, or a non-linearity parameter of an edge transition profile, thereby modifying the high-frequency content generated by waveform transitions. For a communication channel having impedance discontinuities that produce ringing or overshoot, the processor 302 may select a slew-limited or curved-edge time-domain symbol shape that reduces abrupt transitions. For a communication channel having frequency-dependent insertion loss, the processor 302 may select a pre-emphasized time-domain symbol shape that compensates for attenuation while still maintaining controlled edge behavior. In this manner, waveform generation can be configured so that the electrical waveform exhibits a time-domain symbol shape that reduces ringing, overshoot, or concentrated high-frequency energy associated with the current impedance profile, while the receiver reconstructs the corresponding reference using the sideband information.

In a further example, the aspects described herein may be applied to marginal or degraded wired interconnects. Low-cost cables, long cable assemblies, worn connector interfaces, oxidized contacts, or mechanically stressed conductors may produce impedance mismatch, skew, reflection behavior, or frequency-dependent loss that reduces signal margin when fixed symbol geometries are used. The processor 302 may determine the impedance profile during transmission and select a set of symbol encoding parameters that is more tolerant of the measured impairment. For example, the processor 302 may select a time-domain symbol shape having slower edge transitions when reflections are dominant, a longer symbol duration when noise margin is reduced, or a pre-emphasis coefficient when high-frequency attenuation is dominant. The apparatus 300 may thereby maintain data transmission over a communication channel whose characteristics differ from nominal design assumptions, without requiring modification of protocol layers above the physical layer. In field deployments, the telemetry data and degradation alerts described herein may further identify when the communication channel is approaching a service limit.

In a USB-C, Thunderbolt, or similar high-speed peripheral interconnect use case, the communication channel may include a reversible connector, cable assembly, retimer path, or device receptacle subject to cable flex, connector wear, contamination, and cable-to-cable variability. The processor 302 may repeatedly determine the impedance profile of the communication channel and update the selected set of symbol encoding parameters in response to changes detected during normal use. For example, a cable that is bent during operation may exhibit a changed reflection coefficient or insertion loss, and the processor 302 may select a different time-domain symbol shape or adjust at least one parameter of the selected set to compensate for the changed channel behavior. A low-cost cable having higher insertion loss than an expected cable may cause the processor 302 to select a pre-emphasized or widened time-domain symbol shape, while a worn connector may cause the processor 302 to select a shape tolerant of reflections. The communication device may therefore adapt physical-layer waveform generation to the actually connected cable and connector condition without increasing transmit power as the sole compensation mechanism.

In mobile device accessory connectors, the communication channel may be affected by pocket lint, contact oxidation, repeated insertion and removal, moisture residue, or mechanical wear. The processor 302 may use the impedance profile to distinguish intermittent or progressive connector degradation from a stable connection and may select symbol encoding parameters that maintain a usable sampling margin under those conditions. In wireless links, including Bluetooth, Wi-Fi, or ultra-wideband links, an impedance profile may correspond to an effective channel response that includes antenna impedance characteristics, radio frequency front-end behavior, or propagation-path effects, and the processor 302 may adapt symbol shaping without requiring full conventional channel estimation for every symbol. In automotive and industrial interconnects, vibration-induced impedance drift, thermal cycling, electromagnetic interference, and connector aging may alter the communication channel during operation. The processor 302 may repeatedly determine the impedance profile, apply hysteresis to avoid oscillation, and update the selected set of symbol encoding parameters or symbol decoding parameters so that the apparatus 300 remains matched to the changing communication channel.

In secure interconnect use cases, the aspects described herein may provide physical-layer security without requiring encryption at the physical layer. A peripheral, storage device, display interface, sensor module, or anti-tamper subsystem may transmit digital data using time-domain symbol shapes that depend on the measured impedance profile and on a negotiated version of the plurality of sets of symbol encoding parameters. A receiver that has received the sideband information and has access to the compatible symbol library version may generate the at least one reference needed to recover the digital data, while an unauthorized probe that observes only the primary waveform may encounter non-standard, dynamically shaped symbols. For example, a digital rights management interface may use impedance-adaptive symbol encoding so that copied waveforms from one cable or connector condition are not directly decodable on another channel without the corresponding sideband information and symbol reconstruction logic. Similarly, a secure peripheral or anti-tamper system may combine impedance-adaptive encoding with conventional higher-layer security mechanisms, while maintaining compatibility through the negotiation and fallback mechanisms described herein.

The aspects described herein may be implemented in any combination in a communication device or communication system. Transmitter-side functionality, receiver-side functionality, or both may be implemented in a single integrated circuit, in separate integrated circuits coupled through internal interfaces, or in processing elements distributed across multiple devices. For example, impedance profile measurement and symbol selection may be performed in one circuit block, while waveform generation may be performed in a separate line driver or radio frequency front-end circuit. The lookup table storing the plurality of sets of symbol encoding parameters may be stored in read-only memory, flash memory, static random-access memory, dynamic random-access memory, or a firmware-managed memory region, depending on whether the symbol library is fixed, field-configurable, or dynamically loaded during operation.

The functions attributed to the processor 302 may be partitioned between hardware and software according to latency, power, area, and configurability requirements. For example, the symbol morphing engine 404 may be implemented as a hardware accelerator that computes adjusted symbol encoding parameters at a per-symbol rate, while firmware executing on the processor 302 manages lookup table contents, negotiation, telemetry data, fallback conditions, and field updates. In a bidirectional transceiver implementation, the symbol morphing engine 404 and the symbol reconstructor 413 may share arithmetic circuits, memory buffers, or template-generation logic, with the processor 302 configuring the shared resources for transmitter-side operation or receiver-side operation depending on the direction of communication.

The methods described herein may be embodied as instructions stored in a non-transitory computer-readable medium and executed by the processor 302. The non-transitory computer-readable medium may comprise any tangible storage medium capable of storing program code, including embedded memory, flash memory, magnetic storage, optical storage, or semiconductor memory. The stored instructions may cause the processor 302 to determine an impedance profile of a communication channel, select a set of symbol encoding parameters from a plurality of sets based on the impedance profile, encode digital data based on the selected set of symbol encoding parameters, cause transmission of sideband information over an auxiliary channel, determine a set of symbol decoding parameters based on received sideband information, generate at least one reference corresponding to a time-domain symbol shape, and decode received signals using the at least one reference. In a system stack implementation, driver software, firmware, protocol control logic, physical-layer processing logic, and management software may cooperate to execute these operations and to configure measurement intervals, symbol libraries, thresholds, adaptation aggressiveness, and diagnostics reporting.

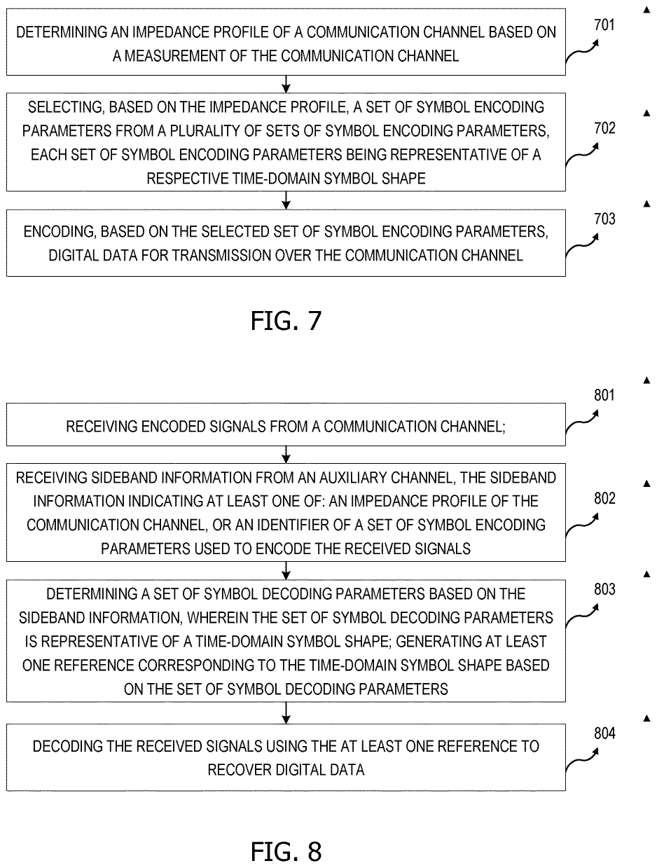

FIG. 7 shows an example of a method. The method includes determining 701 an impedance profile of a communication channel based on a measurement of the communication channel; selecting 702, based on the impedance profile, a set of symbol encoding parameters from a plurality of sets of symbol encoding parameters, each set of symbol encoding parameters being representative of a respective time-domain symbol shape; and encoding 703, based on the selected set of symbol encoding parameters, digital data for transmission over the communication channel. A non-transitory computer-readable medium includes instructions which, if executed by a processor, cause the processor to perform the method.

FIG. 8 shows an example of a method. The method includes receiving 801 encoded signals from a communication channel; receiving 802 sideband information from an auxiliary channel, the sideband information indicating at least one of: an impedance profile of the communication channel, or an identifier of a set of symbol encoding parameters used to encode the received signals; determining 803 a set of symbol decoding parameters based on the sideband information, wherein the set of symbol decoding parameters is representative of a time-domain symbol shape; generating 804 at least one reference corresponding to the time-domain symbol shape based on the set of symbol decoding parameters; and decoding the received signals using the at least one reference to recover digital data. A non-transitory computer-readable medium includes instructions which, if executed by a processor, cause the processor to perform the method.

The following examples pertain to further aspects described herein.

Example 1 includes the subject matter of an apparatus including a processor configured to: determine an impedance profile of a communication channel based on a measurement of the communication channel; select, based on the impedance profile, a set of symbol encoding parameters from a plurality of sets of symbol encoding parameters, each set of symbol encoding parameters being representative of a respective time-domain symbol shape; and encode, based on the selected set of symbol encoding parameters, digital data for transmission over the communication channel.

Example 2 may include the subject matter of example 1, wherein the respective time-domain symbol shape is characterized by at least one of: an edge transition characteristic including a rise time or a fall time; a symbol timing duration; and an amplitude asymmetry between a high voltage state and a low voltage state.

Example 3 may include the subject matter of example 1 or 2, wherein the processor is configured to encode the digital data by generating an electrical waveform representing the digital data on the communication channel, wherein the electrical waveform exhibits the respective time-domain symbol shape represented by the selected set of symbol encoding parameters.

Example 4 may include the subject matter of any one of examples 1 to 3, wherein the processor is configured to determine the impedance profile by causing transmission of a test signal on the communication channel and deriving the impedance profile from a response to the test signal, preferably wherein the test signal includes at least one of: a probe signal injected during data transmission having an amplitude below an amplitude of data signals on the communication channel, or an idle pattern of the communication channel.

Example 5 may include the subject matter of any one of examples 1 to 4, wherein the impedance profile includes at least one of: a differential impedance, a common-mode impedance, a return loss, a reflection coefficient, a frequency-dependent insertion loss, or a crosstalk measure.

Example 6 may include the subject matter of any one of examples 1 to 5, wherein the processor is further configured to apply at least one of filtering or smoothing to the impedance profile prior to selecting the set of symbol encoding parameters.

Example 7 may include the subject matter of any one of examples 1 to 6, wherein the plurality of sets of symbol encoding parameters are stored as entries in a lookup table, each entry being associated with a respective range of values of the impedance profile.

Example 8 may include the subject matter of any one of examples 1 to 7, wherein the symbol encoding parameters of at least one of the sets include at least one of: a rise time, a fall time, an amplitude level, an amplitude asymmetry between a high state and a low state, a pre-emphasis coefficient, an edge timing relative to a clock reference, or a non-linearity parameter of an edge transition profile.

Example 9 may include the subject matter of any one of examples 1 to 8, wherein the symbol encoding parameters of at least one of the sets include at least one of: a symbol duration or a number of unit intervals allocated per symbol.

Example 10 may include the subject matter of any one of examples 1 to 9, wherein the processor is further configured to, after selecting the set of symbol encoding parameters, adjust at least one parameter of the selected set based on the impedance profile, and encode the digital data in accordance with the adjusted set of symbol encoding parameters.

Example 11 may include the subject matter of any one of examples 1 to 10, wherein the processor is further configured to generate telemetry data including at least one of: a history of impedance profile values recorded during transmission, a frequency of symbol set changes, or a symbol error rate associated with each set of symbol encoding parameters, and to make the telemetry data available via a management interface.

Example 12 may include the subject matter of example 11, wherein the processor is further configured to detect degradation of the communication channel by identifying a monotonic trend in the impedance profile over a plurality of successive measurement intervals, and to generate an alert when the trend exceeds a degradation threshold.

Example 13 may include the subject matter of any one of examples 1 to 12, wherein the processor is configured to repeatedly determine the impedance profile during transmission of the digital data over the communication channel.

Example 14 may include the subject matter of example 13, wherein the processor is configured to select a different set of symbol encoding parameters from the plurality of sets in response to a change in the impedance profile.

Example 15 may include the subject matter of any one of examples 13 to 14, wherein the processor is configured to select the set of symbol encoding parameters at a granularity of one of: per transmitted symbol, or per block of transmitted symbols.

Example 16 may include the subject matter of any one of examples 13 to 15, wherein the processor is configured to apply a hysteresis condition to the selection of a different set of symbol encoding parameters, such that a change in the selected set is withheld unless the impedance profile deviates from a value associated with the currently selected set by at least a predetermined threshold.

Example 17 may include the subject matter of any one of examples 1 to 16, wherein the processor is further configured to cause transmission of sideband information over an auxiliary channel, the sideband information indicating at least one of: the impedance profile, or an identifier of the selected set of symbol encoding parameters.

Example 18 may include the subject matter of example 17, wherein the auxiliary channel includes at least one of: in-band coding within reserved symbol positions of the communication channel, a physically separate conductor, or an embedded field within a protocol frame of the communication channel.

Example 19 may include the subject matter of any one of examples 1 to 18, wherein the processor is further configured to negotiate with a remote apparatus connected via the communication channel to establish at least one of: availability of impedance-adaptive encoding, a format of sideband information, or a version of the plurality of sets of symbol encoding parameters. Preferably, the negotiation occurs during a link training phase.

Example 20 may include the subject matter of any one of examples 1 to 19, wherein the processor is further configured to revert to a predetermined fixed encoding scheme when at least one of the following conditions is met: a signal-to-noise ratio of the impedance measurement falls below a threshold, a valid impedance measurement is unavailable, or an error rate in the sideband information exceeds a threshold.

Example 21 may include An apparatus including: a communication channel interface configured to receive encoded signals from a communication channel; an auxiliary channel interface configured to receive sideband information from an auxiliary channel, the sideband information indicating at least one of: an impedance profile of the communication channel, or an identifier of a set of symbol encoding parameters used to encode the received signals; and a processor configured to: determine a set of symbol decoding parameters based on the sideband information, wherein the set of symbol decoding parameters is representative of a time-domain symbol shape; generate at least one reference corresponding to the time-domain symbol shape based on the set of symbol decoding parameters; and decode the received signals using the at least one reference to recover digital data.

Example 22 may include the subject matter of example 21, wherein the at least one reference includes at least one of: a reference waveform template, a set of decision thresholds, or a set of timing boundaries for symbol detection.

Example 23 may include the subject matter of example 21 or example 22, wherein decoding the received signals includes correlating each received symbol with the at least one reference to determine a most likely value of the digital data represented by the received symbol.

Example 24 may include the subject matter of any one of examples 21 to 23, wherein the processor is further configured to update the set of symbol decoding parameters in response to updated sideband information received via the auxiliary channel interface during reception of the encoded signals.

Example 25 may include the subject matter of any one of examples 21 to 24, wherein the processor is further configured to adjust at least one of a clock recovery parameter or an equalization parameter based on the set of symbol decoding parameters. Preferably, the clock recovery parameter and the equalization parameter are parameters of existing clock and data recovery or equalization circuitry of the apparatus.

Example 26 may include the subject matter of any one of examples 21 to 25, wherein the processor is further configured to decode the received signals using at least one of: a slicer with programmable thresholds derived from the set of symbol decoding parameters, or a detector that performs maximum-likelihood or near-maximum-likelihood detection using the at least one reference as a template.

Example 27 may include the subject matter of any one of examples 21 to 26, wherein the processor is further configured to negotiate with a remote apparatus connected via the communication channel to establish at least one of: availability of impedance-adaptive encoding, a format of the sideband information, or a version of a plurality of sets of symbol encoding parameters. Preferably, the negotiation occurs during a link training phase.

Example 28 may include the subject matter of any one of examples 21 to 27, wherein the processor is further configured to revert to a predetermined fixed decoding scheme when the sideband information is absent or does not satisfy a reliability criterion. Preferably, the predetermined fixed decoding scheme corresponds to a legacy encoding scheme of the communication channel.

Example 29 may include the subject matter of any one of examples 21 to 28, wherein the auxiliary channel interface and the communication channel interface share a common physical connection, and the sideband information is received as at least one of: in-band coding within reserved symbol positions, or an embedded field within a protocol frame.

Example 30 may include a communication device including the apparatus of any one of examples 1 to 29; and a communication interface configured to transmit or receive signals.

Example 31 may include the subject matter of a method including: determining an impedance profile of a communication channel based on a measurement of the communication channel; selecting, based on the impedance profile, a set of symbol encoding parameters from a plurality of sets of symbol encoding parameters, each set of symbol encoding parameters being representative of a respective time-domain symbol shape; and encoding, based on the selected set of symbol encoding parameters, digital data for transmission over the communication channel.

Example 32 may include the subject matter of example 31, wherein the respective time-domain symbol shape is characterized by at least one of: an edge transition characteristic including a rise time or a fall time; a symbol timing duration; and an amplitude asymmetry between a high voltage state and a low voltage state.

Example 33 may include the subject matter of example 31 or 32, wherein encoding the digital data includes generating an electrical waveform representing the digital data on the communication channel, wherein the electrical waveform exhibits the respective time-domain symbol shape represented by the selected set of symbol encoding parameters.

Example 34 may include the subject matter of any one of examples 31 to 33, wherein determining the impedance profile includes causing transmission of a test signal on the communication channel and deriving the impedance profile from a response to the test signal, preferably wherein the test signal includes at least one of: a probe signal injected during data transmission having an amplitude below an amplitude of data signals on the communication channel, or an idle pattern of the communication channel.

Example 35 may include the subject matter of any one of examples 31 to 34, wherein the impedance profile includes at least one of: a differential impedance, a common-mode impedance, a return loss, a reflection coefficient, a frequency-dependent insertion loss, or a crosstalk measure.

Example 36 may include the subject matter of any one of examples 31 to 35, may further include applying at least one of filtering or smoothing to the impedance profile prior to selecting the set of symbol encoding parameters.

Example 37 may include the subject matter of any one of examples 31 to 36, wherein the plurality of sets of symbol encoding parameters are stored as entries in a lookup table, each entry being associated with a respective range of values of the impedance profile.

Example 38 may include the subject matter of any one of examples 31 to 37, wherein the symbol encoding parameters of at least one of the sets include at least one of: a rise time, a fall time, an amplitude level, an amplitude asymmetry between a high state and a low state, a pre-emphasis coefficient, an edge timing relative to a clock reference, or a non-linearity parameter of an edge transition profile.

Example 39 may include the subject matter of any one of examples 31 to 38, wherein the symbol encoding parameters of at least one of the sets include at least one of: a symbol duration or a number of unit intervals allocated per symbol.

Example 40 may include the subject matter of any one of examples 31 to 39, may further include, after selecting the set of symbol encoding parameters, adjusting at least one parameter of the selected set based on the impedance profile, and encoding the digital data in accordance with the adjusted set of symbol encoding parameters.

Example 41 may include the subject matter of any one of examples 31 to 40, may further include generating telemetry data including at least one of: a history of impedance profile values recorded during transmission, a frequency of symbol set changes, or a symbol error rate associated with each set of symbol encoding parameters, and making the telemetry data available via a management interface.

Example 42 may include the subject matter of example 41, may further include detecting degradation of the communication channel by identifying a monotonic trend in the impedance profile over a plurality of successive measurement intervals, and generating an alert when the trend exceeds a degradation threshold.

Example 43 may include the subject matter of any one of examples 31 to 42, wherein the impedance profile is repeatedly determined during transmission of the digital data over the communication channel.

Example 44 may include the subject matter of example 43, wherein a different set of symbol encoding parameters is selected from the plurality of sets in response to a change in the impedance profile.

Example 45 may include the subject matter of any one of examples 43 to 44, wherein the set of symbol encoding parameters is selected at a granularity of one of: per transmitted symbol, or per block of transmitted symbols.

Example 46 may include the subject matter of any one of examples 43 to 45, wherein a hysteresis condition is applied to the selection of a different set of symbol encoding parameters, such that a change in the selected set is withheld unless the impedance profile deviates from a value associated with the currently selected set by at least a predetermined threshold.

Example 47 may include the subject matter of any one of examples 31 to 46, may further include causing transmission of sideband information over an auxiliary channel, the sideband information indicating at least one of: the impedance profile, or an identifier of the selected set of symbol encoding parameters.

Example 48 may include the subject matter of example 47, wherein the auxiliary channel includes at least one of: in-band coding within reserved symbol positions of the communication channel, a physically separate conductor, or an embedded field within a protocol frame of the communication channel.

Example 49 may include the subject matter of any one of examples 31 to 48, may further include negotiating with a remote apparatus connected via the communication channel to establish at least one of: availability of impedance-adaptive encoding, a format of sideband information, or a version of the plurality of sets of symbol encoding parameters, preferably wherein the negotiation occurs during a link training phase.

Example 50 may include the subject matter of any one of examples 31 to 49, may further include reverting to a predetermined fixed encoding scheme when at least one of the following conditions is met: a signal-to-noise ratio of the impedance measurement falls below a threshold, a valid impedance measurement is unavailable, or an error rate in the sideband information exceeds a threshold.

Example 51 may include the subject matter of a method including: receiving encoded signals from a communication channel; receiving sideband information from an auxiliary channel, the sideband information indicating at least one of: an impedance profile of the communication channel, or an identifier of a set of symbol encoding parameters used to encode the received signals; determining a set of symbol decoding parameters based on the sideband information, wherein the set of symbol decoding parameters is representative of a time-domain symbol shape; generating at least one reference corresponding to the time-domain symbol shape based on the set of symbol decoding parameters; and decoding the received signals using the at least one reference to recover digital data.

Example 52 may include the subject matter of example 51, wherein the at least one reference includes at least one of: a reference waveform template, a set of decision thresholds, or a set of timing boundaries for symbol detection.

Example 53 may include the subject matter of example 51 or example 52, wherein decoding the received signals includes correlating each received symbol with the at least one reference to determine a most likely value of the digital data represented by the received symbol.

Example 54 may include the subject matter of any one of examples 51 to 53, may further include updating the set of symbol decoding parameters in response to updated sideband information received via the auxiliary channel during reception of the encoded signals.

Example 55 may include the subject matter of any one of examples 51 to 54, may further include adjusting at least one of a clock recovery parameter or an equalization parameter based on the set of symbol decoding parameters, preferably wherein the clock recovery parameter and the equalization parameter are parameters of existing clock and data recovery or equalization circuitry.

Example 56 may include the subject matter of any one of examples 51 to 55, wherein decoding the received signals is performed using at least one of: a slicer with programmable thresholds derived from the set of symbol decoding parameters, or a detector that performs maximum-likelihood or near-maximum-likelihood detection using the at least one reference as a template.

Example 57 may include the subject matter of any one of examples 51 to 56, may further include negotiating with a remote apparatus connected via the communication channel to establish at least one of: availability of impedance-adaptive encoding, a format of the sideband information, or a version of a plurality of sets of symbol encoding parameters, preferably wherein the negotiation occurs during a link training phase.

Example 58 may include the subject matter of any one of examples 51 to 57, may further include reverting to a predetermined fixed decoding scheme when the sideband information is absent or does not satisfy a reliability criterion, preferably wherein the predetermined fixed decoding scheme corresponds to a legacy encoding scheme of the communication channel.

Example 59 may include the subject matter of any one of examples 51 to 58, wherein the sideband information and the encoded signals are received via a shared common physical connection, and the sideband information is received as at least one of: in-band coding within reserved symbol positions, or an embedded field within a protocol frame.

Example 60 may include a non-transitory computer-readable medium including instructions which, if executed by a processor, cause the processor to perform the method of any one of examples 31 to 59.

The apparatuses and methods described herein may utilize or be related to radio communication technologies. While some examples may refer to specific radio communication technologies, the examples provided herein may be similarly applied to various other radio communication technologies, both existing and not yet formulated, particularly in cases where such radio communication technologies share similar features as disclosed regarding the following examples. Various exemplary radio communication technologies that the apparatuses and methods described herein may utilize include, but are not limited to: a Global System for Mobile Communications (“GSM”) radio communication technology, a General Packet Radio Service (“GPRS”) radio communication technology, an Enhanced Data Rates for GSM Evolution (“EDGE”) radio communication technology, and/or a Third Generation Partnership Project (“3GPP”) radio communication technology, for example Universal Mobile Telecommunications System (“UMTS”), Freedom of Multimedia Access (“FOMA”), 3GPP Long Term Evolution (“LTE”), 3GPP Long Term Evolution Advanced (“LTE Advanced”), Code division multiple access 2000 (“CDMA2000”), Cellular Digital Packet Data (“CDPD”), Mobitex, Third Generation (3G), Circuit Switched Data (“CSD”), High-Speed Circuit-Switched Data (“HSCSD”), Universal Mobile Telecommunications System (“Third Generation”) (“UMTS (3G)”), Wideband Code Division Multiple Access (Universal Mobile Telecommunications System) (“W-CDMA (UNITS)”), High Speed Packet Access (“HSPA”), High-Speed Downlink Packet Access (“HSDPA”), High-Speed Uplink Packet Access (“HSUPA”), High Speed Packet Access Plus (“HSPA+”), Universal Mobile Telecommunications System-Time-Division Duplex (“UMTS-TDD”), Time Division-Code Division Multiple Access (“TD-CDMA”), Time Division-Synchronous Code Division Multiple Access (“TD-CDMA”), 3rd Generation Partnership Project Release 8 (Pre-4th Generation) (“3GPP Rel. 8 (Pre-4G)”), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17), 3GPP Rel. 18 (3rd Generation Partnership Project Release 18), 3GPP 4G, 3GPP LTE Extra, LTE-Advanced Pro, LTE Licensed-Assisted Access (“LAA”), MuLTEfire, UMTS Terrestrial Radio Access (“UTRA”), Evolved UMTS Terrestrial Radio Access (“E-UTRA”), Long Term Evolution Advanced (4th Generation) (“LTE Advanced (4G)”), cdmaOne (“2G”), Code division multiple access 2000 (Third generation) (“CDMA2000 (3G)”), Evolution-Data Optimized or Evolution-Data Only (“EV-DO”), Advanced Mobile Phone System (1st Generation) (“AMPS (1G)”), Total Access Communication arrangement/Extended Total Access Communication arrangement (“TACS/ETACS”), Digital AMPS (2nd Generation) (“D-AMPS (2G)”), Push-to-talk (“PTT”), Mobile Telephone System (“MTS”), Improved Mobile Telephone System (“IMTS”), Advanced Mobile Telephone System (“AMTS”), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (“Autotel/PALM”), ARP (Finnish for Autoradiopuhelin, “car radio phone”), NMT (Nordic Mobile Telephony), High capacity version of NTT (Nippon Telegraph and Telephone) (“Hicap”), Cellular Digital Packet Data (“CDPD”), Mobitex, DataTAC, Integrated Digital Enhanced Network (“iDEN”), Personal Digital Cellular (“PDC”), Circuit Switched Data (“CSD”), Personal Handy-phone System (“PHS”), Wideband Integrated Digital Enhanced Network (“WiDEN”), iBurst, Unlicensed Mobile Access (“UMA”), also referred to as also referred to as 3GPP Generic Access Network, or GAN standard), Zigbee, Bluetooth®, Wireless Gigabit Alliance (“WiGig”) standard, mmWave standards in general (wireless systems operating at 10-300 GHz and above such as WiGig, IEEE 802.11ad, IEEE 802.11ay, Wi-Fi, IEEE 802.11bq, etc.), technologies operating above 300 GHz and THz bands, (3GPP/LTE based or IEEE 802.11p and other) Vehicle-to-Vehicle (“V2V”) and Vehicle-to-X (“V2X”) and Vehicle-to-Infrastructure (“V2I”) and Infrastructure-to-Vehicle (“I2V”) communication technologies, 3GPP cellular V2X, DSRC (Dedicated Short Range Communications) communication arrangements such as Intelligent-Transport-Systems, and other existing, developing, or future radio communication technologies.

The apparatuses and methods described herein may use such radio communication technologies according to various spectrum management schemes, including, but not limited to, dedicated licensed spectrum, unlicensed spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System in 3.55-3.7 GHz and further frequencies), and may use various spectrum bands including, but not limited to, IMT (International Mobile Telecommunications) spectrum (including 450-470 MHz, 690-960 MHz, 1710-2025 MHz, 2110-2200 MHz, 2300-2400 MHz, 2500-2690 MHz, 698-790 MHz, 610-790 MHz, 3400-3600 MHz, etc., where some bands may be limited to specific region(s) and/or countries), IMT-advanced spectrum, IMT-2020 spectrum (expected to include 3600-3800 MHz, 3.5 GHz bands, 600 MHz bands, bands within the 24.25-86 GHz range, etc.), spectrum made available under FCC's “Spectrum Frontier” 4G initiative (including 27.5-28.35 GHz, 29.1-29.25 GHz, 31-31.3 GHz, 37-38.6 GHz, 38.6-40 GHz, 42-42.5 GHz, 47-64 GHz, 64-71 GHz, 61-76 GHz, 81-86 GHz and 92-94 GHz, etc.), the ITS (Intelligent Transport Systems) band of 4.9 GHz (typically 4.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), the 60.2 GHz-71 GHz band, any band between 65.88 GHz and 61 GHz, bands currently allocated to automotive radar applications such as 66-81 GHz, the 57-71 GHz band allocated for mmWave Wi-Fi (802.11bq) and future bands including 94-300 GHz and above. Furthermore, the apparatuses and methods described herein can also employ radio communication technologies on a secondary basis on bands such as the TV White Space bands (typically below 690 MHz) where e.g., the 400 MHz and 600 MHz bands are prospective candidates. Besides cellular applications, specific applications for vertical markets may be addressed such as PMSE (program making and special events), medical, health, surgery, automotive, low-latency, drones, etc. applications. Furthermore, the apparatuses and methods described herein may also use radio communication technologies with a hierarchical application, such as by introducing a hierarchical prioritization of usage for different types of users (e.g., low/medium/high priority, etc.), based on a prioritized access to the spectrum e.g., with highest priority to tier-1 users, followed by tier-2, then tier-3, etc. users, etc. The apparatuses and methods described herein can also use radio communication technologies with different single carrier or OFDM flavors (CP-OFDM, SC-FDMA, SC-OFDM, filter bank-based multicarrier (FBMC), OFDMA, etc.) and e.g., 3GPP NR (New Radio), which can include allocating the OFDM carrier data bit vectors to the corresponding symbol resources.

As described herein, radio communication technologies may be classified as one of a short range radio communication technology or cellular wide area radio communication technology. Short range radio communication technologies may include Bluetooth, WLAN (e.g., according to any IEEE 802.11 standard), and other similar radio communication technologies. Cellular wide area radio communication technologies may include Global System for Mobile Communications (“GSM”), Code Division Multiple Access 2000 (“CDMA2000”), Universal Mobile Telecommunications System (“UMTS”), Long Term Evolution (“LTE”), General Packet Radio Service (“GPRS”), Evolution-Data Optimized (“EV-DO”), Enhanced Data Rates for GSM Evolution (“EDGE”), High Speed Packet Access (HSPA; including High Speed Downlink Packet Access (“HSDPA”), High Speed Uplink Packet Access (“HSUPA”), HSDPA Plus (“HSDPA+”), and HSUPA Plus (“HSUPA+”)), Worldwide Interoperability for Microwave Access (“WiMax”) (e.g., according to an IEEE 802.16 radio communication standard, e.g., WiMax fixed or WiMax mobile), etc., and other similar radio communication technologies. Cellular Wide Area radio communication technologies also include “small cells” of such technologies, such as microcells, femtocells, and picocells. cellular wide area radio communication technologies may be generally referred to herein as “cellular” communication technologies.

In the context of wireless local area network, the apparatuses and methods described herein may be for various wireless devices, including access points (APs) and wireless station devices (STAs), each may be equipped with radio frequency communication capabilities. These devices may incorporate transmission and reception components designed to handle RF signals within specified bandwidths and channels as described herein. The communication components typically include both hardware elements and software implementations for signal processing, enabling modulation and demodulation according to specified communication protocols. These devices may particularly be configured to operate under various wireless communication standards, including those developed by the Institute of Electrical and Electronics Engineers (IEEE) for Wi-Fi applications. The radio frequency components, working in conjunction with antenna systems, enable communication across multiple frequency bands. These frequency bands may include, among others, the 2.4 GHz band supporting protocols such as IEEE 802.11b/g/n/ax, the 5 GHz band supporting IEEE 802.11n/ac/ax/be, and the 6 GHz band supporting newer standards like IEEE 802.11ax/be. Additional operational frequencies may extend to 60 GHz (supporting IEEE 802.11 ad/ay/bq) and 800 MHz (supporting IEEE 802.11ah), with antenna systems capable of operating at frequencies such as 28 GHz and 40 GHz. Beyond these specified standards, the devices may support emerging Wi-Fi protocols and alternative wireless communication technologies. These alternatives may include, but are not limited to, Bluetooth technology, dedicated short-range communication systems, Ultra-high frequency applications (including IEEE 802.11af and IEEE 802.22), and white band frequency utilization. The radio frequency reception chain may typically incorporate essential components such as low noise amplifiers, signal amplification stages, analog-to-digital conversion systems, data buffering mechanisms, and digital baseband processing units, all configured to ensure effective wireless communication capabilities.

The word “exemplary” is used herein to mean “serving as an example, instance, or illustration”. Any embodiment or design described herein as “exemplary” is not necessarily to be construed as preferred or advantageous over other embodiments or designs.

The words “plurality” and “multiple” in the description or the claims expressly refer to a quantity greater than one. The terms “group (of)”, “set [of]”, “collection (of)”, “series (of)”, “sequence (of)”, “grouping (of)”, etc., and the like in the description or in the claims refer to a quantity equal to or greater than one, i.e., one or more. Any term expressed in plural form that does not expressly state “plurality” or “multiple” likewise refers to a quantity equal to or greater than one.

Any vector and/or matrix notation utilized herein is exemplary in nature and is employed solely for purposes of explanation. Accordingly, the apparatuses and methods of described herein accompanied by vector and/or matrix notation are not limited to being implemented solely using vectors and/or matrices, and that the associated processes and computations may be equivalently performed with respect to sets, sequences, groups, etc., of data, observations, information, signals, samples, symbols, elements, etc.

As used herein, “memory” is understood as a non-transitory computer-readable medium in which data or information can be stored for retrieval. References to “memory” included herein may thus be understood as referring to volatile or non-volatile memory, including random access memory (“RAM”), read-only memory (“ROM”), flash memory, solid-state storage, magnetic tape, hard disk drive, optical drive, etc., or any combination thereof. Furthermore, registers, shift registers, processor registers, data buffers, etc., are also embraced herein by the term memory. A single component referred to as “memory” or “a memory” may be composed of more than one different type of memory, and thus may refer to a collective component including one or more types of memory. Any single memory component may be separated into multiple collectively equivalent memory components, and vice versa. Furthermore, while memory may be depicted as separate from one or more other components (such as in the drawings), memory may also be integrated with other components, such as on a common integrated chip or a controller with an embedded memory.

The term “software” refers to any type of executable instruction, including firmware.

In the context described herein, the term “process” may be used, for example, to indicate a method. Illustratively, any process described herein may be implemented as a method (e.g., a channel estimation process may be understood as a channel estimation method). Any process described herein may be implemented as a non-transitory computer readable medium including instructions configured, when executed, to cause one or more processors to carry out the process (e.g., to carry out the method).

Throughout the drawings, it should be noted that like reference numbers are used to depict the same or similar elements, features, and structures, unless otherwise noted. It should be noted that certain components may be omitted for the sake of simplicity. It should be noted that nodes (dots) are provided to identify the circuit line intersections in the drawings including electronic circuit diagrams.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

As used herein, a signal or information that is “indicative of”, “representative”, “representing”, or “indicating” a value or other information may be a digital or analog signal that encodes or otherwise, communicates the value or other information in a manner that can be decoded by and/or cause a responsive action in a component receiving the signal. The signal may be stored or buffered in computer-readable storage medium prior to its receipt by the receiving component and the receiving component may retrieve the signal from the storage medium. Further, a “value” that is “indicative of” or “representative” some quantity, state, or parameter may be physically embodied as a digital signal, an analog signal, or stored bits that encode or otherwise communicate the value.

As used herein, a signal may be transmitted or conducted through a signal chain in which the signal is processed to change characteristics such as phase, amplitude, frequency, and so on. The signal may be referred to as the same signal even as such characteristics are adapted. In general, so long as a signal continues to encode the same information, the signal may be considered as the same signal. For example, a transmit signal may be considered as referring to the transmit signal in baseband, intermediate, and radio frequencies.

The terms “processor” or “controller” as, for example, used herein may be understood as any kind of technological entity that allows handling of data. The data may be handled according to one or more specific functions executed by the processor. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, central processing unit (CPU), graphics processing unit (GPU), neural processing unit (NPU), digital signal processor (DSP), field programmable gate array (FPGA), integrated circuit, application specific integrated circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The terms “one or more processors” is intended to refer to a processor or a controller. The one or more processors may include one processor or a plurality of processors. The terms are simply used as an alternative to the “processor” or “controller”.

As utilized herein, terms “module”, “component,” “system,” “circuit,” “element,” “slice,” “circuit,” and the like are intended to refer to a set of one or more electronic components, a computer-related entity, hardware, software (e.g., in execution), and/or firmware. For example, circuit or a similar term can be a processor, a process running on a processor, a controller, an object, an executable program, a storage device, and/or a computer with a processing device. By way of illustration, an application running on a server and the server can also be circuit. One or more circuits can reside within the same circuit, and circuit can be localized on one computer and/or distributed between two or more computers. A set of elements or a set of other circuits can be described herein, in which the term “set” can be interpreted as “one or more”.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art. The term “data item” may include data or a portion of data.

It will be understood that when an element is referred to as being “connected” or “coupled” to another element, it can be physically connected or coupled to the other element such that current and/or electromagnetic radiation (e.g., a signal) can flow along a conductive path formed by the elements. Inherently, such element is connectable or couplable to the another element. Intervening conductive, inductive, or capacitors may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “provided” to an element, the voltage, current, or signal may be conducted to the element by way of a physical connection or by way of capacitive, electro-magnetic, or inductive coupling that does not involve a physical connection.

Unless explicitly specified, the term “instance of time” refers to a time of a particular event or situation according to the context. The instance of time may refer to an instantaneous point in time, or to a period of time which the particular event or situation relates to.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

While the above descriptions and connected figures may depict electronic device components as separate elements, skilled persons will appreciate the various possibilities to combine or integrate discrete elements into a single element. Such may include combining two or more circuits to form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method. All acronyms defined in the above description additionally hold in all claims included herein.

What is claimed is:

1. An apparatus comprising a processor configured to:
determine an impedance profile of a communication channel based on a measurement of the communication channel;
select, based on the impedance profile, a set of symbol encoding parameters from a plurality of sets of symbol encoding parameters, each set of symbol encoding parameters being representative of a respective time-domain symbol shape; and
encode, based on the selected set of symbol encoding parameters, digital data for transmission over the communication channel.

2. The apparatus of claim 1, wherein the respective time-domain symbol shape is characterized by at least one of: an edge transition characteristic including a rise time or a fall time; a symbol timing duration; and an amplitude asymmetry between a high voltage state and a low voltage state.

3. The apparatus of claim 1, wherein the processor is configured to encode the digital data by generating an electrical waveform representing the digital data on the communication channel, wherein the electrical waveform exhibits the respective time-domain symbol shape represented by the selected set of symbol encoding parameters.

4. The apparatus of claim 1, wherein the processor is configured to determine the impedance profile by causing transmission of a test signal on the communication channel and deriving the impedance profile from a response to the test signal, preferably wherein the test signal comprises at least one of: a probe signal injected during data transmission having an amplitude below an amplitude of data signals on the communication channel, or an idle pattern of the communication channel.

5. The apparatus of claim 1, wherein the impedance profile comprises at least one of: a differential impedance, a common-mode impedance, a return loss, a reflection coefficient, a frequency-dependent insertion loss, or a crosstalk measure.

6. The apparatus of claim 1, wherein the symbol encoding parameters of at least one of the sets comprise at least one of: a rise time, a fall time, an amplitude level, an amplitude asymmetry between a high state and a low state, a pre-emphasis coefficient, an edge timing relative to a clock reference, or a non-linearity parameter of an edge transition profile.

7. The apparatus of claim 1, wherein the symbol encoding parameters of at least one of the sets comprise at least one of: a symbol duration or a number of unit intervals allocated per symbol.

8. The apparatus of claim 1, wherein the processor is further configured to, after selecting the set of symbol encoding parameters, adjust at least one parameter of the selected set based on the impedance profile, and encode the digital data in accordance with the adjusted set of symbol encoding parameters.

9. The apparatus of claim 1, wherein the processor is further configured to generate telemetry data comprising at least one of: a history of impedance profile values recorded during transmission, a frequency of symbol set changes, or a symbol error rate associated with each set of symbol encoding parameters, and to make the telemetry data available via a management interface.

10. The apparatus of claim 9, wherein the processor is further configured to detect degradation of the communication channel by identifying a monotonic trend in the impedance profile over a plurality of successive measurement intervals, and to generate an alert when the trend exceeds a degradation threshold.

11. The apparatus of claim 1, wherein the processor is configured to repeatedly determine the impedance profile during transmission of the digital data over the communication channel, and wherein the processor is configured to select a different set of symbol encoding parameters from the plurality of sets in response to a change in the impedance profile.

12. The apparatus of claim 1, wherein the processor is further configured to cause transmission of sideband information over an auxiliary channel, the sideband information indicating at least one of: the impedance profile, or an identifier of the selected set of symbol encoding parameters, wherein the auxiliary channel comprises at least one of: in-band coding within reserved symbol positions of the communication channel, a physically separate conductor, or an embedded field within a protocol frame of the communication channel.

13. An apparatus comprising:
a communication channel interface configured to receive encoded signals from a communication channel;
an auxiliary channel interface configured to receive sideband information from an auxiliary channel, the sideband information indicating at least one of: an impedance profile of the communication channel, or an identifier of a set of symbol encoding parameters used to encode the received signals; and
a processor configured to:
determine a set of symbol decoding parameters based on the sideband information, wherein the set of symbol decoding parameters is representative of a time-domain symbol shape;
generate at least one reference corresponding to the time-domain symbol shape based on the set of symbol decoding parameters; and
decode the received signals using the at least one reference to recover digital data.

14. The apparatus of claim 13, wherein the at least one reference comprises at least one of: a reference waveform template, a set of decision thresholds, or a set of timing boundaries for symbol detection.

15. The apparatus of claim 13, wherein decoding the received signals comprises correlating each received symbol with the at least one reference to determine a most likely value of the digital data represented by the received symbol.

16. The apparatus of claim 13, wherein the processor is further configured to update the set of symbol decoding parameters in response to updated sideband information received via the auxiliary channel interface during reception of the encoded signals.

17. The apparatus of claim 13, wherein the processor is further configured to adjust at least one of a clock recovery parameter or an equalization parameter based on the set of symbol decoding parameters.

18. The apparatus of claim 13, wherein the auxiliary channel interface and the communication channel interface share a common physical connection, and the sideband information is received as at least one of: in-band coding within reserved symbol positions, or an embedded field within a protocol frame.

19. A communication device comprising an apparatus comprising:
a processor configured to:
determine an impedance profile of a communication channel based on a measurement of the communication channel;
select, based on the impedance profile, a set of symbol encoding parameters from a plurality of sets of symbol encoding parameters, each set of symbol encoding parameters being representative of a respective time-domain symbol shape; and
encode, based on the selected set of symbol encoding parameters, digital data for transmission over the communication channel; and
a communication interface configured to transmit encoded signals.

20. The communication device of claim 19, further comprising a measurement circuit configured to perform the measurement of the communication channel.
